(19) United States
(12) Patent Application Publication
(10) Pub. No.: US 2025/0353306 A1
(43) Pub. Date: Nov. 20, 2025

(54) TANK INCLUDING FRAME DEFINING FIRST OPENING, AND COVER COVERING AT LEAST PART OF FIRST OPENING

(71) Applicant: BROTHER KOGYO KABUSHIKI KAISHA, Nagoya (JP)

(72) Inventors: Fumiya NAKAMURA, Nagoya (JP); Masahiro HAYASHI, Anjo (JP)

(73) Assignee: BROTHER KOGYO KABUSHIKI KAISHA, Nagoya (JP)

(21) Appl. No.: 19/207,511

(22) Filed: May 14, 2025

(30) Foreign Application Priority Data
May 16, 2024 (JP) 2024-080360

(51) Int. Cl. B41J 2/175

(52) U.S. Cl. CPC B41J 2/1754; B41J 2/17509; B41J 2/17556; B41J 2/17566; B41J 2/17596; B41J 2002/17573

(57) ABSTRACT

A tank includes a frame and a cover. The frame defines a storage chamber for storing liquid and a first opening. The first opening faces in a downward direction or in a horizontal direction in a state where the tank is attached to a liquid ejection device. The cover is fixed to the frame. The cover covers at least part of the first opening. The strength of the cover is greater than the strength of a film.

### REFERENCE TO RELATED APPLICATIONS

This application claims priority from Japanese Patent Application No. 2024-080360 filed on May 16, 2024. The entire content of the priority application is incorporated herein by reference.

### BACKGROUND ART

A known ink tank is attachable to a multifunction peripheral, and includes a frame and two films. The frame includes an ink chamber and an inlet. The frame has two openings. One of the openings opens leftward and the other of the openings opens rightward. Each of the two films is welded to the entire periphery of the corresponding one of the openings. As a result, the openings of the frame are sealed.

### SUMMARY

During attachment of the ink tank to the multifunction peripheral, the film may be damaged or deformed due to the ink tank coming in contact with the housing of the multifunction peripheral, or with any component provided in the multifunction peripheral. Furthermore, during replenishment of ink to the ink tank, the film may be damaged or deformed due to the film receiving a load from the ink stored in the ink chamber.

In view of the foregoing, it is an object of the present disclosure to provide a tank, the strength of which can be easily ensured, and a liquid ejection device including the tank.

In order to attain the above and other objects, according to one aspect, the present disclosure provides a tank including a frame and a cover. The frame defines a storage chamber for storing liquid and a first opening. The first opening faces in a downward direction or in a horizontal direction in a state where the tank is attached to a liquid ejection device. The cover is fixed to the frame. The cover covers at least part of the first opening. The strength of the cover is greater than the strength of a film.

According to another aspect, the present disclosure provides a liquid ejection device including the tank, a head, and a tank cover. The head is configured to eject liquid stored in the tank. The tank cover covers the tank. The tank cover includes a fixing portion and a cover portion. The fixing portion is for positioning a bottle relative to the tank in a state where the bottle is connected to the tank. The cover portion covers at least part of the cover of the tank.

In the above structures, since the strength of the cover is greater than the strength of the film, the strength of the tank can be easily ensured than a tank in which the first opening is covered by the film. Accordingly, when the tank is attached to the inner surface of the casing of the liquid ejection device, the likelihood of the cover being damaged or deformed can be reduced, even if the cover contacts the inner surface of the casing and any component provided in the liquid ejection device, or receives a load from liquid stored in the storage chamber.

### BRIEF DESCRIPTION OF DRAWINGS

FIG. 1 is a perspective view of the external appearance of a multifunction peripheral 10.

FIG. 2 is a longitudinal cross-sectional view schematically illustrating the internal structure of a printing unit 11.

FIG. 3 is a plan view illustrating the arrangement of a carriage 23 and an ink tank 100.

FIG. 4 is a perspective view of an ink tank set 51.

FIG. 5 is a perspective view of the ink tank 100.

FIG. 6 is a cross-sectional view of the ink tank set 51 taken along a plane containing an ink chamber 111D, viewed from an upward and forward diagonal perspective.

FIG. 7 is a bottom view of a tank main body 120.

FIG. 8 is a schematic diagram illustrating the components of the ink tank 100.

FIG. 9 is a perspective view of the ink tank 100, viewed from a downward perspective.

FIG. 10 is a cross-sectional view of the ink tank 100 taken along a horizontal plane above a bottom wall 105, viewed from an upward perspective.

FIG. 11 is a perspective view of the ink tank 100 viewed from a downward perspective.

FIG. 12 is a cross-sectional view of the ink tank 100, where ink chambers 111 are viewed from in a downward and rearward diagonal perspective.

FIG. 13 is a longitudinal cross-sectional view of the ink tank set 51 taken along a plane containing the ink chamber 111D.

FIG. 14 is a cross-sectional view of the ink tank 100, where the ink chambers 111 are viewed from a rearward perspective.

FIG. 15 is a top view of a tank cap 127.

FIG. 16 is a front view of the tank cap 127.

FIG. 17 is a right-side view of the tank cap 127.

FIG. 18 is a rear view of the tank cap 127.

FIG. 19 is a bottom view of the tank cap 127.

FIG. 20 is a longitudinal cross-sectional view of the tank cap 127.

FIG. 21 is a perspective view of an ink bottle 80.

FIG. 22 is a longitudinal cross-sectional view of the ink tank set 51 and the ink bottle 80 connected thereto, taken along a plane containing an ink chamber 111A.

FIG. 23 is a schematic diagram illustrating a film 121 covering a portion of an opening 231 proving communication between the interior and exterior of an ink chamber 111.

FIG. 24 is a cross-sectional view of the ink tank set 51 illustrating an upper plate 174, taken along a plane containing the ink chamber 111D.

FIG. 25 is a cross-sectional view of the ink tank set 51 illustrating an upper plate 174, taken along a plane containing the ink chamber 111D.

FIG. 26 is a cross-sectional view of the ink tank set 51 illustrating an upper plate 174, taken along a plane containing the ink chamber 111D.

FIG. 27 is a schematic diagram illustrating a tank tube 115 welded to a horizontal surface 104B of a top wall 104.

FIG. 28 is a schematic diagram illustrating a tank tube 115 welded to a sloped surface 104A of the top wall 104.

FIG. 29 is a schematic diagram illustrating that a right wall 102 and a film 121 can be fixed to a tank main body 120 which opens leftward.

FIG. 30 is a schematic diagram illustrating that a right wall 102 from which a right wall rib 189 is omitted, can be welded to a tank main body 120 from which a main body rib 188 is omitted.

FIG. 31 is a cross-sectional view of an ink tank 100, wherein a portion of an opening 231 of a variation of tank main body 120 which opens rightward, is covered by an outflow tube 331 of a right wall 102.

FIG. 32 is a right-side view of a right wall 102.

FIG. 33 is a cross-sectional view of the ink tank 100, wherein the entirety of an opening 231 of a tank main body 120 which opens rightward, is being covered by an outflow tube 331 and a film 121.

FIG. 34 is a cross-sectional view of a tank cap 127 being restricted by a stopper part 179.

FIG. 35 is a plan view of a tank cap 127 being restricted by the stopper part 179.

FIG. 36 is another plan view of a tank cap 127 being restricted by the stopper part 179.

FIG. 37 is another plan view of a tank cap 127 being restricted by the stopper part 179.

FIG. 38 is a plan view illustrating a method of attaching a tank cap 127.

FIG. 39 is a cross-sectional view of a valve 251 assembled between a tubular portion 104C of a top wall 104 and a base 252.

### DESCRIPTION

Hereinafter, an embodiment of the present disclosure will be described. It should be understood that the following embodiment is merely an example of the disclosure, and that this embodiment may be modified as appropriate without departing from the spirit of the disclosure. In the following description, both directions of a bidirectional arrow are collectively referred to as a “direction”. In other words, both an upward direction and a downward direction are components of an up-down direction and are opposite each other. Both a leftward direction and a rightward direction are components of a left-right direction and are opposite each other. Both a frontward direction (i.e., a forward direction) and a rearward direction are components of a front-rear direction and are opposite each other. Also, in this embodiment, the up-down direction corresponds to a vertical direction and the front-rear direction and left-right direction correspond to horizontal directions.

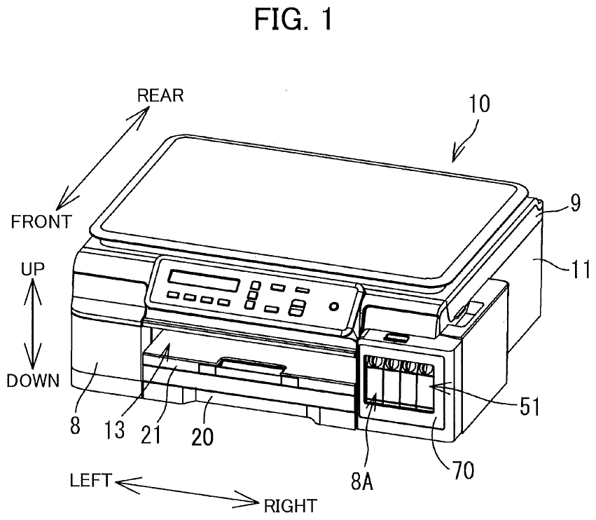

Further, the up-down direction is defined based on a state or an orientation of a multifunction peripheral 10 which is placed and ready for use; the front-rear direction is defined on the assumption that the side of the multifunction peripheral 10 at which an opening 13 is provided is a front side; and the left-right direction is defined based on the perspective of the user viewing the multifunction peripheral 10 from the front side. The state of the multifunction peripheral 10 shown in FIG. 1 will be sometimes referred to as the “usable state”. The orientation of the multifunction peripheral 10 shown in FIG. 1 will be sometimes referred to as the “usable orientation”. The front surface of multifunction peripheral 10 is at the front side of the multifunction peripheral 10, at which the opening 13 is provided.

Further, for each component in the multifunction peripheral 10, the center of the component in the left-right direction will be simply referred to as the “left-right center of the component”. The same applies to the up-down direction and the front-rear direction.

### <Overall Configuration of the Multifunction Peripheral 10>

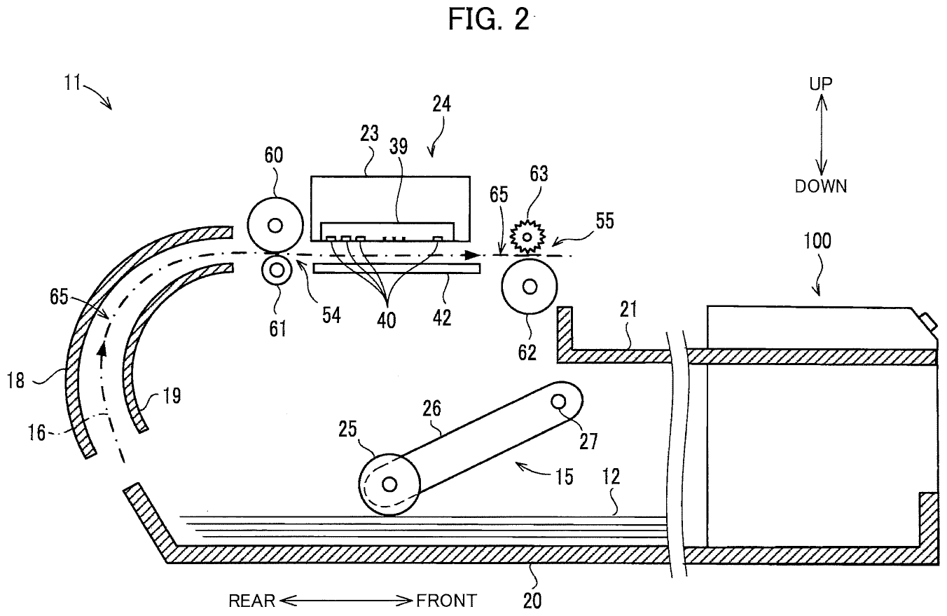

As shown in FIG. 1, the multifunction peripheral 10 includes a general rectangular parallelepiped casing 8. The multifunction peripheral 10 further includes a scanning unit 9 and a printing unit 11, which are arranged in the internal space of the casing 8. The scanning unit 9 is positioned in the upper portion of the internal space of the casing 8. The scanning unit 9 has a scanning function. The printing unit 11 is positioned further downward than the scanning unit 9 in the internal space of the casing 8. The printing unit 11 has a printing function. The printing unit 11 is configured to record images on sheets 12 shown in FIG. 2 according to an inkjet recording method. As shown in FIGS. 1 and 2, the printing unit 11 includes a feeding unit 15, a feed tray 20, a discharge tray 21, a conveying path 65, a conveying roller set 54, a recording unit 24, a discharge roller set 55, a platen 42, and an ink tank set 51. Incidentally, the scanning unit 9 may be omitted from the multifunction peripheral 10. The multifunction peripheral 10 is an example of the liquid ejection device.

The casing 8 has an opening 8A positioned further rightward than the opening 13. The opening 8A provides a communication between the external space and internal space of the casing 8. The ink tank set 51 described later is configured to be attached to the inner surface of the casing 8 through the opening 8A. The casing 8 includes a cover 70 configured to close the opening 8A. The cover 70 is pivotable about a pivot axis extending in the left-right direction at the bottom end of the cover 70. The cover 70 is pivotable between a covering position and an exposing position. At the covering position shown in FIG. 1, the cover 70 covers the opening 8A of the casing 8. At the exposing position, the cover 70 exposes the opening 8A of the casing 8 to the outside of the multifunction peripheral 10. In other words, the cover 70 is pivotable between the covering position (FIG. 1) at which the cover 70 covers the ink tank set 51, and the exposing position at which the cover 70 exposes the ink tank set 51 to the outside of the multifunction peripheral 10. The cover 70 has an opening. The ink tank set 51 has a portion exposed to the outside of the multifunction peripheral 10 through the opening of the cover 70 even when the cover 70 is at the covering position. Here, the portion of the ink tank set 51 being exposed to the outside of the multifunction peripheral 10 through the opening of the cover 70 signifies that a user outside the multifunction peripheral 10 can see at least part of the ink tank set 51 through the opening of the cover 70 from the outside of the multifunction peripheral 10, and does not signify that part of the ink tank set 51 protrudes to the outside of the multifunction peripheral 10 through the opening of the cover 70.

### <Feed Tray 20 and Discharge Tray 21>

As shown in FIG. 1, the multifunction peripheral 10 has the opening 13 formed in the front surface of the multifunction peripheral 10. The opening 13 is positioned in the left-right center of the multifunction peripheral 10. Through user operations, the feed tray 20 is movable in the front-rear direction through the opening 13. As shown in FIG. 2, the feed tray 20 supports a plurality of sheets 12 in a stacked state. The discharge tray 21 is positioned further upward than the feed tray 20. The discharge tray 21 is movable in the front-rear direction together with the feed tray 20. The discharge tray 21 supports sheets 12 discharged by the discharge roller set 55.

### <Feeding Unit 15>

The feeding unit 15 is configured to feed sheets 12 supported on the feed tray 20 onto the conveying path 65. As shown in FIG. 2, the feeding unit 15 includes a feed roller 25, a feed arm 26, and a shaft 27. The feed roller 25 is rotatably supported on the distal end of the feed arm 26. The feed roller 25 is configured to rotate in a direction for conveying sheets 12 in a conveying direction 16 by receiving a drive force transmitted from a conveying motor (not shown). Hereinafter, the feed roller 25 rotating in the direction for conveying the sheet 12 in the conveying direction 16 will be expressed as “the feed roller 25 rotating forward.” The same applies to a conveying roller 60 (described later) and a discharge roller 62 (described later). The shaft 27 is supported by a frame of the printing unit 11. The feed arm 26 is rotatably supported by the shaft 27. The feed arm 26 is urged to rotate toward the feed tray 20 by its own weight or the elastic force of a spring or the like.

### <Conveying Path 65>

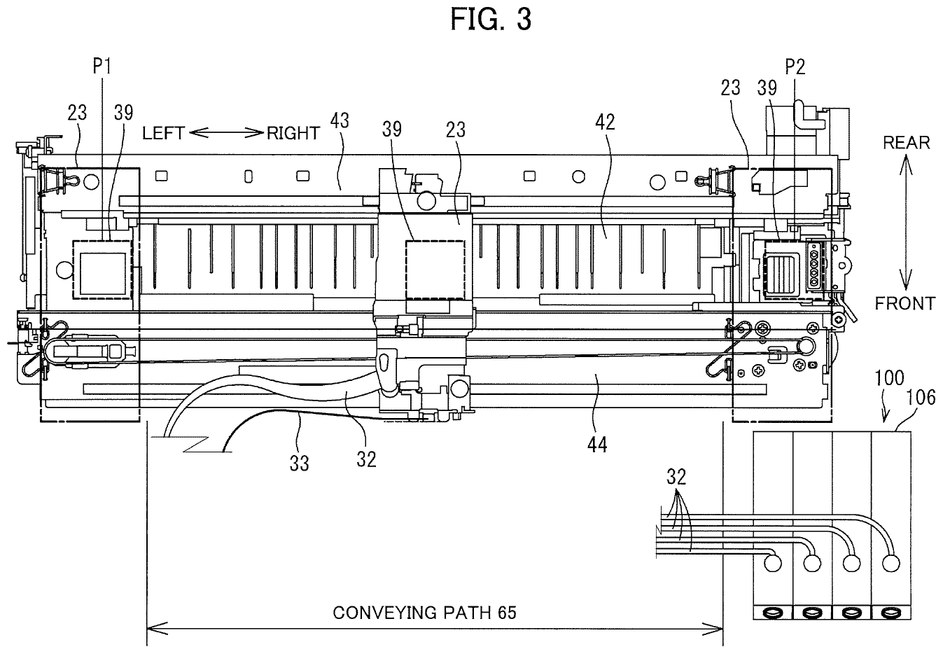

As shown in FIG. 2, the conveying path 65 denotes a space defined by an outer guide member 18 and an inner guide member 19 that face each other with a predetermined interval therebetween, for example. The conveying path 65 extends from the rear end portion of the feed tray 20 toward the rear of the printing unit 11, extends upward in the rear of the printing unit 11 while making a U-turn, and passes through a space between the recording unit 24 and platen 42 to reach the discharge tray 21. As shown in FIGS. 2 and 3, the section of the conveying path 65 between the conveying roller set 54 and the discharge roller set 55 is positioned in the approximate left-right center of the multifunction peripheral 10 and extends in the front-rear direction. Arrows depicted with one-dot chain lines in FIG. 2 indicate the conveying direction 16 of sheets 12 in the conveying path 65.

### <Conveying Roller Set 54>

As shown in FIG. 2, the conveying roller set 54 is positioned upstream of the recording unit 24 in the conveying direction 16. The conveying roller set 54 includes the conveying roller 60 and a pinch roller 61. The conveying roller 60 and pinch roller 61 face each other in the up-down direction. The conveying roller 60 is configured to rotate by receiving a drive force transmitted from the conveying motor. The pinch roller 61 is configured to rotate in accordance with the rotation of the conveying roller 60. When the conveying roller 60 is driven to rotate forward by the forward rotation of the conveying motor, a sheet 12 nipped between the conveying roller 60 and pinch roller 61 is conveyed in the conveying direction 16.

### <Discharge Roller Set 55>

As shown in FIG. 2, the discharge roller set 55 is positioned downstream of the recording unit 24 in the conveying direction 16. The discharge roller set 55 includes the discharge roller 62 and spurs 63. The discharge roller 62 and spurs 63 face each other in the up-down direction. The discharge roller 62 is configured to rotate by receiving a drive force transmitted from the conveying motor. The spurs 63 are configured to rotate in accordance with the rotation of the discharge roller 62. When the discharge roller 62 is driven to rotate forward by the forward rotation of the conveying motor, a sheet 12 nipped between the discharge roller 62 and the spurs 63 is conveyed in the conveying direction 16.

### <Recording Unit 24>

As shown in FIG. 2, the recording unit 24 is positioned between the conveying roller set 54 and the discharge roller set 55 in the conveying direction 16. The recording unit 24 faces the platen 42 in the up-down direction with the conveying path 65 interposed therebetween. The recording unit 24 is positioned further upward than the conveying path 65 in the up-down direction. The recording unit 24 includes a carriage 23, and a recording head 39.

As shown in FIG. 3, the carriage 23 is supported by guide rails 43 and 44. The guide rails 43 and 44 are supported by the frame of the printing unit 11. The guide rails 43 and 44 are spaced apart from each other in the front-rear direction. Each of the guide rails 43 and 44 extends in the left-right direction. The guide rails 43 and 44 extend further outward than the conveying path 65 in the left-right direction. The carriage 23 is coupled to a well-known belt mechanism provided on the guide rail 44. The belt mechanism rotates by receiving a drive force transmitted from a carriage motor (not shown). When the belt mechanism rotates, the carriage 23 moves in the left-right direction. The moving range of the carriage 23 is indicated by the one-dot chain lines shown in FIG. 3. The carriage 23 is configured to move further rightward and leftward than the conveying path 65 in the left-right direction.

The recording head 39 is connected to an ink tank 100 by ink tubes 32. The recording head 39 is electrically connected to a control board by a flexible flat cable 33. A control unit (not shown) is mounted on the control board. Both the ink tubes 32 and flexible flat cable 33 extend from the carriage 23. The ink tubes 32 are configured to supply ink stored in the ink tank 100 to the recording head 39. The flexible flat cable 33 is configured to transmit control signals outputted from the control unit to the recording head 39.

As shown in FIGS. 2 and 3, the carriage 23 supports the recording head 39. In other words, the recording head 39 is mounted on the carriage 23. The recording head 39 is movable between a standby position P1 and a maintenance position P2 in the left-right direction in accordance with the movement of the carriage 23. The standby position P1 is positioned further leftward than the conveying path 65. The maintenance position P2 is positioned further rightward than the conveying path 65. A plurality of nozzles 40 is formed in the bottom surface of the recording head 39. The recording head 39 is configured to eject ink from the nozzles 40 in the form of minute ink droplets. The recording head 39 ejects ink droplets toward a sheet 12 supported on the platen 42 as the carriage 23 moves. Hence, an image is recorded on the sheet 12. The recording head 39 is an example of the head.

### <Platen 42>

As shown in FIGS. 2 and 3, the platen 42 is positioned between the conveying roller set 54 and discharge roller set 55 in the conveying direction 16. The platen 42 faces the recording unit 24 in the up-down direction. The platen 42 is configured to support the bottom of a sheet 12 being conveyed by the conveying roller set 54.

### <Ink Tank Set 51>

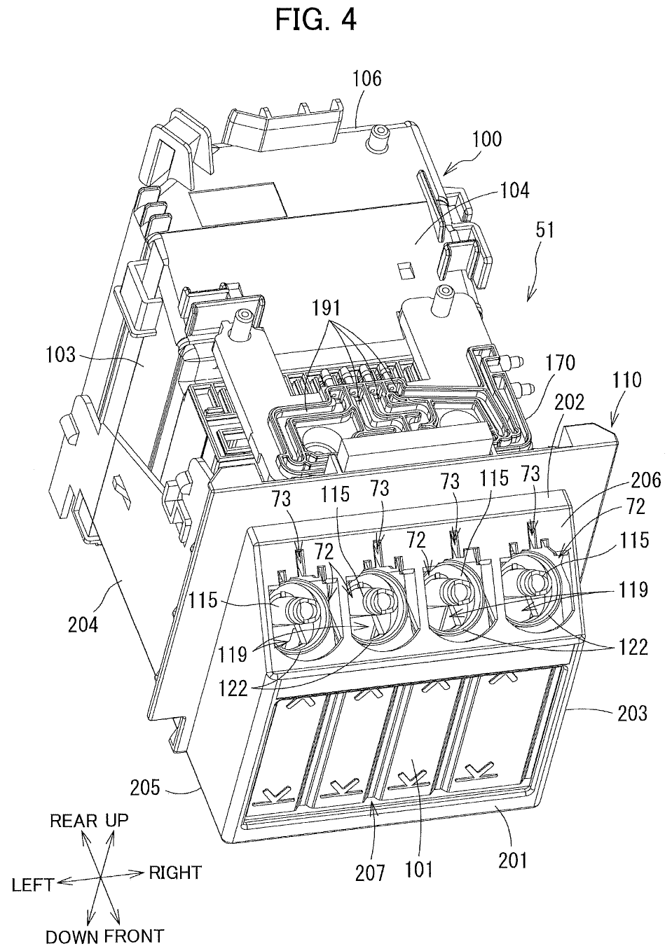

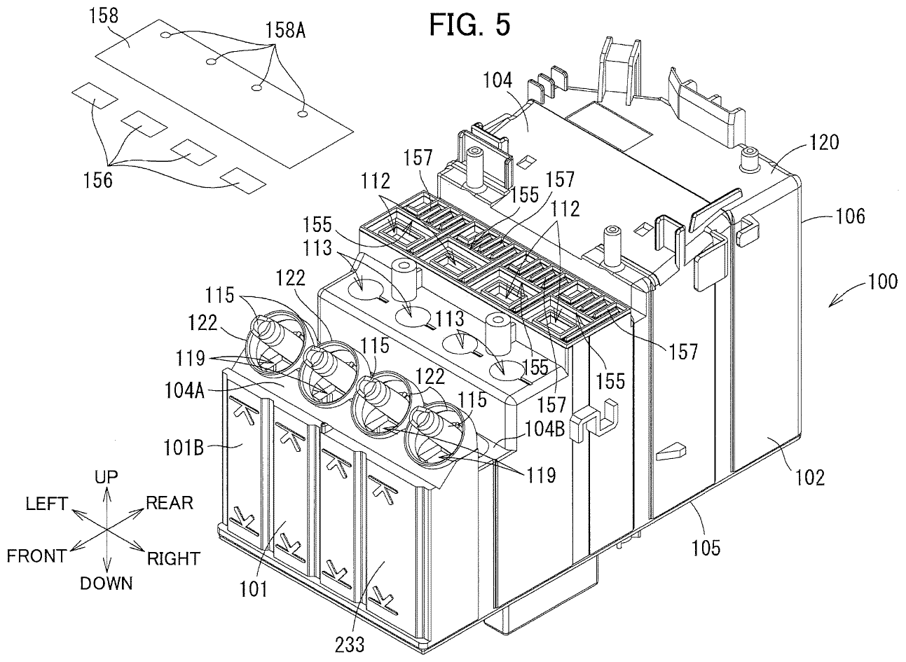

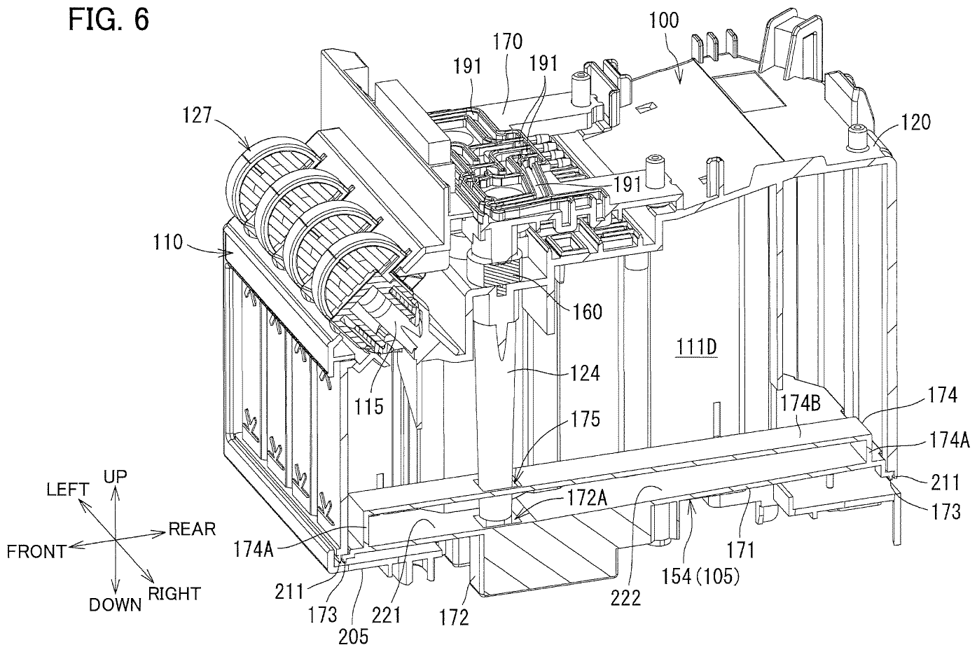

As shown in FIGS. 4 and 6, the ink tank set 51 includes the ink tank 100, a tank cover 110, and tank caps 127. In other words, the multifunction peripheral 10 includes the ink tank 100, the tank cover 110, and the tank caps 127. Note that the tank caps 127 are omitted in FIGS. 4 and 5. Incidentally, the tank cover 110 may be omitted from the multifunction peripheral 10. As shown in FIG. 1, the ink tank set 51 is positioned in the internal space of the casing 8. The ink tank set 51 is attached to the inner surface of the casing 8 through the opening 8A of the casing 8 so that a user cannot easily remove the ink tank set 51 from the multifunction peripheral 10. Note that the front-rear direction, the up-down direction, and the left-right direction of the ink tank set 51 will be described based on the orientation of the ink tank set 51 attached to the inner surface of the casing 8. The casing 8 is an example of the housing. The ink tank 100 is an example of the tank.

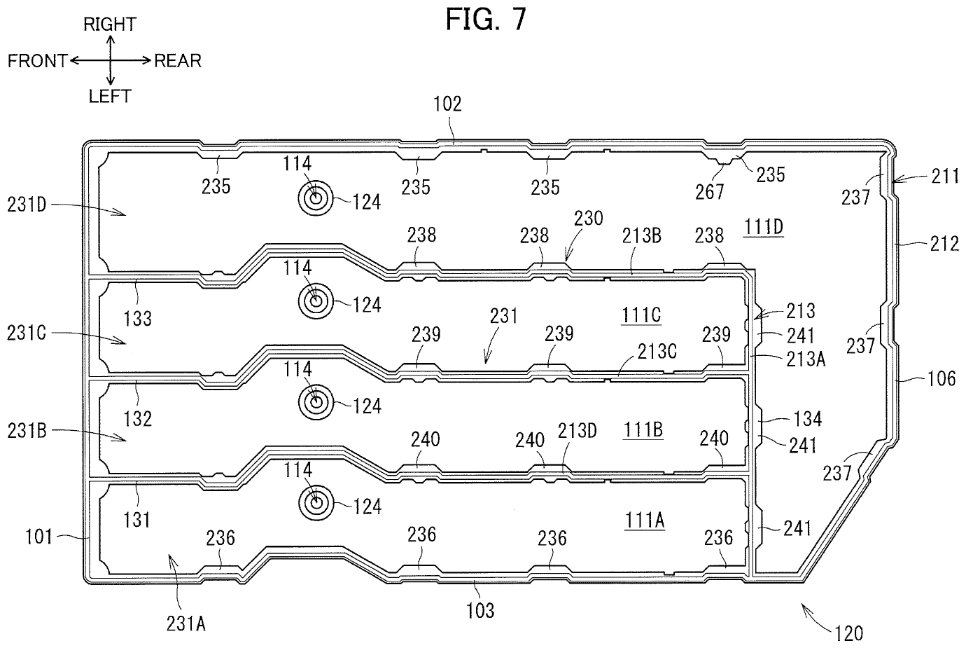

The ink tank 100 includes ink chambers 111 configured to store ink therein. In this embodiment, as shown in FIGS. 6 and 7, the ink tank 100 includes four ink chambers 111A, 111B, 111C, and 111D in the inside of the ink tank 100. The four ink chambers 111A, 111B, 111C, and 111D are juxtaposed in the left-right direction and in this order from left. The three ink chambers 111A, 111B, and 111C store ink in different colors. Specifically, the three ink chambers 111A, 111B, and 111C store ink in one of the colors yellow, cyan, and magenta. The ink chamber 111D stores black ink. The ink is an example of the liquid. Note that types of inks include: pigment inks including pigments; and dye inks containing dyes, for example. Incidentally, each of the ink chambers 111A, 111B, 111C, and 111D may store cleaning liquid therein in place of ink. Examples of the cleaning liquid includes water. The cleaning liquid is an example of the liquid. Incidentally, each of the ink chambers 111A, 111B, 111C, and 111D may store, in place of ink, a pretreatment liquid that is ejected from the recording head 39 onto a sheet prior to ejecting ink during performing a printing. The pretreatment liquid is an example of the liquid. Incidentally, water which is to be sprayed to near the nozzles 40 of the recording head 39 for reducing the likelihood of the nozzles 40 of the recording head 39 becoming dry, may be an example of the liquid. The four ink chambers 111A, 111B, 111C, and 111D are each an example of the storage chamber.

As shown in FIGS. 4, 5, 7, and 8, the ink tank 100 has a general rectangular parallelepiped external shape. The ink tank 100 includes a tank main body 120, a bottom wall 105, and a film 121. The tank main body 120 includes a front wall 101, a right wall 102, a left wall 103, a top wall 104, a rear wall 106, and four partition walls 131, 132, 133, and 134. The front wall 101, right wall 102, left wall 103, top wall 104, rear wall 106, and the four partition walls 131, 132, 133, and 134 are formed as a single piece by injection molding a resin material. In this embodiment, the tank main body 120 is molded as a single piece using a die in which a core is pulled out from a cavity in the up-down direction. Hence, the tank main body 120 opens downward. The opening which opens downward is an opening 231 described later. The tank main body 120 is made of resin capable of being welded. The tank main body 120 is formed of polypropylene, for example. The tank main body 120 is an example of the frame.

Each of the front wall 101, right wall 102, left wall 103, top wall 104, and rear wall 106 has such a translucency that the levels of inks stored in the ink tank 100 are visible from outside the ink tank 100. The front wall 101 has a front surface 101B having a viewing surface 233 through which the four ink chambers 111A, 111B, 111C, and 111D are visible from the front of the ink tank 100.

The partition walls 131, 132, and 133 are arranged at intervals in the left-right direction. Each of the partition walls 131, 132, and 133 has a flat plate shape extending in the front-rear and up-down directions. The partition wall 131 is positioned further rightward than the left wall 103 with the partition wall 131 spaced apart from the left wall 103. The partition wall 132 is positioned further rightward than the partition wall 131 with the partition wall 132 spaced apart from the partition wall 131. The partition wall 133 is positioned further rightward than the partition wall 132 with the partition wall 133 spaced apart from the partition wall 132. The front edges of the partition walls 131, 132, and 133 connect to the rear surface of the front wall 101. The top edges of the partition walls 131, 132, and 133 connect to the bottom surface of the top wall 104. The bottom edges of the partition walls 131, 132, and 133 connect to the top surface of the bottom wall 105.

The partition wall 134 is positioned further rearward than the partition walls 131, 132, and 133. The partition wall 134 has a flat plate shape extending in the up-down and left-right directions. The front surface of the partition wall 134 connects to the rear edges of the partition walls 131, 132, and 133 and the right surface of the left wall 103. The partition wall 134 extends from the rear edge of the partition wall 133 to the right surface of the left wall 103.

The tank main body 120 includes protruding walls 230 protruding from the inner surface of the tank main body 120. Specifically, the protruding wall 230 includes right outer protruding walls 235, left outer protruding walls 236, rear outer protruding walls 237, right inner protruding walls 238, center inner protruding walls 239, left inner protruding walls 240, and rear inner protruding walls 241.

The right outer protruding walls 235 protrude leftward from the left surface of the right wall 102. Each right outer protruding wall 235 extends from the bottom edge of the right wall 102 to the top edge of the right wall 102 in the up-down direction. As shown in FIG. 7, the four right outer protruding walls 235 are arranged at intervals in the front-rear direction. The rearmost right outer protruding wall 235, which is one of the four right outer protruding walls 235, includes a protrusion 267. The protrusion 267 extends leftward from the left surface of the rearmost right outer protruding wall 235. The right outer protruding walls 235 are each an example of the first protruding wall.

The left outer protruding walls 236 protrude rightward from the right surface of the left wall 103. Each left outer protruding wall 236 extends from the bottom edge of the left wall 103 to the top edge of the left wall 103 in the up-down direction. As shown in FIG. 7, the four left outer protruding walls 236 are arranged at intervals in the front-rear direction. The left outer protruding walls 236 are each an example of the first protruding wall.

The rear outer protruding wall 237 protrudes forward from the front surface of the rear wall 106. Each rear outer protruding wall 237 extends from the bottom edge of the rear wall 106 to the top edge of the rear wall 106 in the up-down direction. As shown in FIG. 7, the three rear outer protruding walls 237 are arranged at intervals in the left-right direction. The rear outer protruding walls 237 are each an example of the first protruding wall.

The right inner protruding walls 238 protrude rightward from the right surface of the partition wall 133. Each right inner protruding wall 238 extends from the bottom edge of the partition wall 133 and the top edge of the partition wall 133 in the up-down direction. As shown in FIG. 7, the three right inner protruding walls 238 are arranged at intervals in the front-rear direction. In the left-right direction, the frontmost right inner protruding wall 238 faces the second right outer protruding wall 235 from the front. In the left-right direction, the center right inner protruding wall 238 faces the third right outer protruding wall 235 from the front. In the left-right direction, the rearmost right inner protruding wall 238 faces the rearmost right outer protruding wall 235. The right inner protruding walls 238 are each an example of the second protruding wall.

The center inner protruding walls 239 protrude rightward from the right surface of the partition wall 132. Each center inner protruding wall 239 extends from the bottom edge of the partition wall 132 to the top edge of the partition wall 132 in the up-down direction. As shown in FIG. 7, the three center inner protruding walls 239 are arranged at intervals in the front-rear direction.

The left inner protruding walls 240 protrude rightward from the right surface of the partition wall 131. Each left inner protruding wall 240 extends from the bottom edge of the partition wall 131 to the top edge of the partition wall 131 in the up-down direction. As shown in FIG. 7, the three left inner protruding walls 240 are arranged at intervals in the front-rear direction.

The rear inner protruding walls 241 protrude rearward from the rear surface of the partition wall 134. Each rear inner protruding wall 241 extends from the bottom edge of the partition wall 134 to the top edge of the partition wall 134 in the up-down direction. As shown in FIG. 7, the three rear protruding inner walls 241 are arranged at intervals in the left-right direction. In the front-rear direction, the rightmost rear inner protruding wall 241 faces the center rear outer protruding wall 237. The rightmost rear inner protruding wall 241 is an example of the second protruding wall.

The ink chamber 111A is defined by the rear surface of the front wall 101, the right surface of the left wall 103, the bottom surface of the top wall 104, the left surface of the partition wall 131, and the front surface of the partition wall 134. The ink chamber 111B is defined by the rear surface of the front wall 101, the bottom surface of the top wall 104, the right surface of the partition wall 131, the left surface of the partition wall 132, and the front surface of the partition wall 134. The ink chamber 111C is defined by the rear surface of the front wall 101, the bottom surface of the top wall 104, the right surface of the partition wall 132, the left surface of the partition wall 133, and the front surface of the partition wall 134.

The ink chamber 111D is defined by the rear surface of the front wall 101, the left surface of the right wall 102, the bottom surface of the top wall 104, the front surface of the rear wall 106, the right surface of the partition wall 133, and the rear surface of the partition wall 134. The ink chamber 111D has an L-shape which extends rearward from the rear surface of the front wall 101 and then is bent leftward. The rear portion of the ink chamber 111D is positioned further rearward than the three ink chambers 111A, 111B, and 111C. The capacity of the ink chamber 111D is greater than the capacity of each of the ink chambers 111A, 111B, and 111C. Incidentally, the front wall 101, right wall 102, rear wall 106, partition wall 133, and partition wall 134 need not necessarily be parallel to the up-down direction.

As shown in FIG. 7, the tank main body 120 includes a main body rib 211 on the bottom edge of the tank main body 120. The main body rib 211 includes an outer rib 212 and an inner rib 213. The outer rib 212 protrudes slightly downward from the bottom edges of the front wall 101, right wall 102, left wall 103, and rear wall 106. The outer rib 212 has an annular shape continuously formed along the bottom edges of the front wall 101, right wall 102, left wall 103, and rear wall 106.

The inner rib 213 protrudes slightly downward from the bottom edges of the partition walls 131, 132, 133, and 134. The inner rib 213 includes a rear inner rib 213A, a right inner rib 213B, a center inner rib 213C, and a left inner rib 213D. The rear inner rib 213A is positioned on the bottom edge of the partition wall 134. The rear inner rib 213A extends from the left edge of the bottom edge of the partition wall 134 to the right edge of the bottom edge of the partition wall 134. The left edge of the rear inner rib 213A is continuous with the outer rib 212. The right inner rib 213B is positioned on the bottom edge of the partition wall 133. The right inner rib 213B extends from the front edge of the bottom edge of the partition wall 133 to the rear edge of the bottom edge of the partition wall 133. The front edge of the right inner rib 213B is continuous with the outer rib 212. The rear edge of the right inner rib 213B is continuous with the rear inner rib 213A. The center inner rib 213C is positioned on the bottom edge of the partition wall 132. The center inner rib 213C extends from the front edge of the bottom edge of the partition wall 132 to the rear edge of the bottom edge of the partition wall 132. The front edge of the center inner rib 213C is continuous with the outer rib 212. The rear edge of the center inner rib 213C is continuous with the rear inner rib 213A. The left inner rib 213D is positioned on the bottom edge of the partition wall 131. The left inner rib 213D extends from the front edge of the bottom edge of the partition wall 131 to the rear edge of the bottom edge of the partition wall 131. The front edge of the left inner rib 213D is continuous with the outer rib 212. The rear edge of the left inner rib 213D is continuous with the rear inner rib 213A.

The outer rib 212, left inner rib 213D, and rear inner rib 213A define an opening 231A. The interior and exterior of the ink chamber 111A are in communication with each other through the opening 231A. The outer rib 212, left inner rib 213D, center inner rib 213C, and rear inner rib 213A define an opening 231B. The interior and exterior of the ink chamber 111B are in communication with each other through the opening 231B. The outer rib 212, center inner rib 213C, right inner rib 213B, and rear inner rib 213A define an opening 231C. The interior and exterior of the ink chamber 111C are in communication with each other through the opening 231C. The outer rib 212, right inner rib 213B, and rear inner rib 213A define an opening 231D. The interior and exterior of the ink chamber 111D are in communication with each other through the opening 231D. The openings 231A, 231B, 231C, and 231D are each an example of the first opening. In the following description of the present embodiment, the four openings 231A, 231B, 231C, and 231D will be collectively referred to as an opening 231 when referring to all the four openings 231A, 231B, 231C, and 231D.

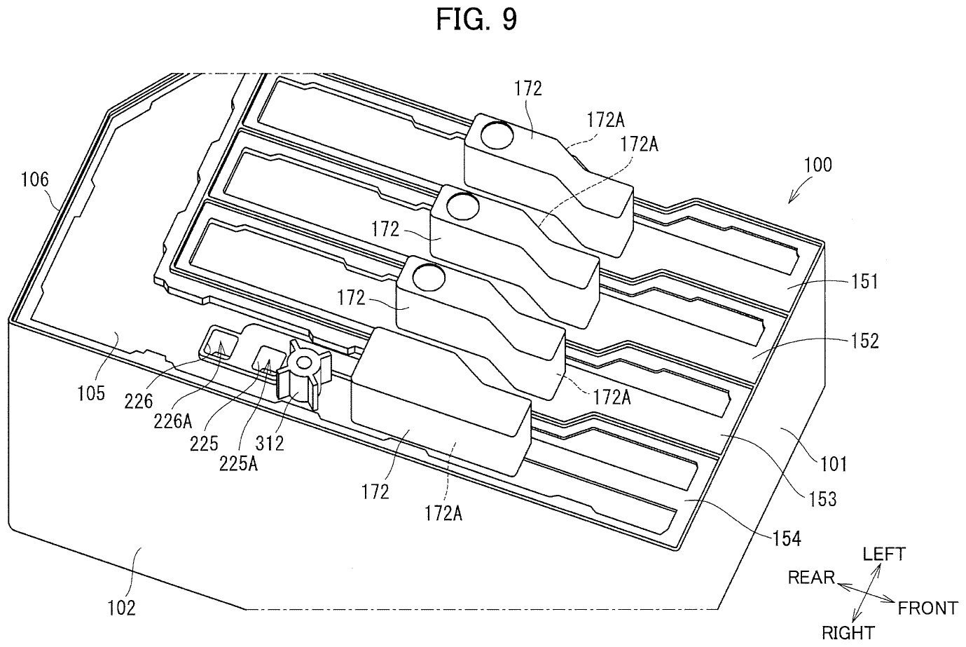

The bottom wall 105 is positioned on the bottoms of the four ink chambers 111A, 111B, 111C, and 111D. The bottom wall 105 is formed of resin capable of being welded. The bottom wall 105 may be formed of polypropylene, for example. As shown in FIG. 9, the bottom wall 105 includes a first bottom wall 151, a second bottom wall 152, a third bottom wall 153, and a fourth bottom wall 154. The bottom wall 105 is an example of the cover.

As shown in FIGS. 7 and 9, the top surface of the fourth bottom wall 154 is in contact with the bottom edges of the front wall 101, right wall 102, rear wall 106, partition wall 133, and partition wall 134 along the entire periphery. In other words, the fourth bottom wall 154 is in contact with the entire periphery of the opening 231D. Hence, the fourth bottom wall 154 covers the entire opening 231D through which the interior and exterior of the ink chamber 111D are in communication with each other. In this state, the top surface of the fourth bottom wall 154 is in contact with the four right outer protruding walls 235, the three rear outer protruding walls 237, the three right inner protruding walls 238, and the three rear protruding inner walls 241. The fourth bottom wall 154 is an example of the cover. As shown in FIG. 6, the fourth bottom wall 154 includes a bottom plate 171, a protruding portion 172, a bottom wall rib 173, and an upper plate 174.

The bottom plate 171 has a flat plate shape extending in the front-rear and left-right directions. The top surface of the bottom plate 171 has a horizontal surface 221 and a sloped surface 222. The horizontal surface 221 is positioned in the front portion of the top surface of the bottom plate 171. The horizontal surface 221 is a horizontal surface extending in the front-rear and left-right directions. The horizontal surface 221 extends from the portion of the top surface of the bottom plate 171 which is positioned slightly forward than the front-rear center of the bottom plate 171, to the front end of the top surface of the bottom plate 171. The sloped surface 222 extends from the rear end of the top surface of the horizontal plate 221 to the rear end of the top surface of the bottom plate 171. The sloped surface 222 is sloped relative to the front-rear direction so as to diagonally extend in the frontward direction and in the downward direction.

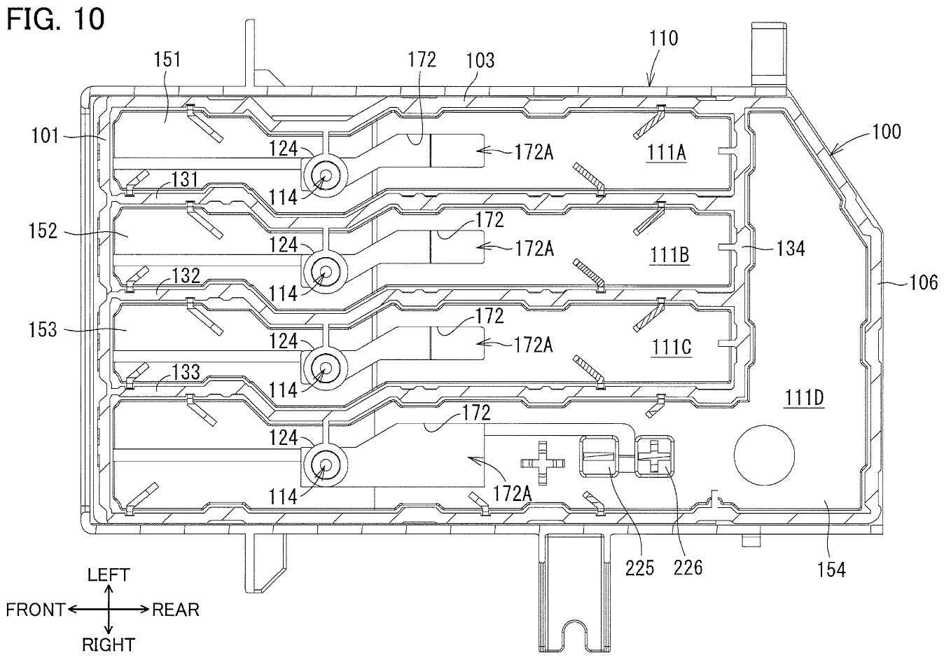

As shown in FIGS. 9 and 10, the protruding portion 172 is positioned across the horizontal surface 221 and the sloped surface 222. Specifically, the protruding portion 172 is positioned on a border portion between the horizontal surface 221 and the sloped surface 222. The protruding portion 172 protrudes from the horizontal surface 221 and the sloped surface 222 and protrudes further downward than the bottom surface of the bottom plate 171. The inner surface of the protruding portion 172 defines a protruding space 172A. The protruding space 172A has a generally rectangular parallelepiped shape elongated in the front-rear direction. In the horizontal surface 221 and sloped surface 222, the protruding space 172A opens upward. The protruding space 172A is capable of storing ink therein. The bottom portion of the ink chamber 111A is defined by the horizontal surface 221, sloped surface 222, and the bottom surface of the protruding portion 172. The protruding portion 172 is an example of the protruding portion. The protruding space 172A is an example of the internal space. The bottom plate 171 is an example of the bottom plate part.

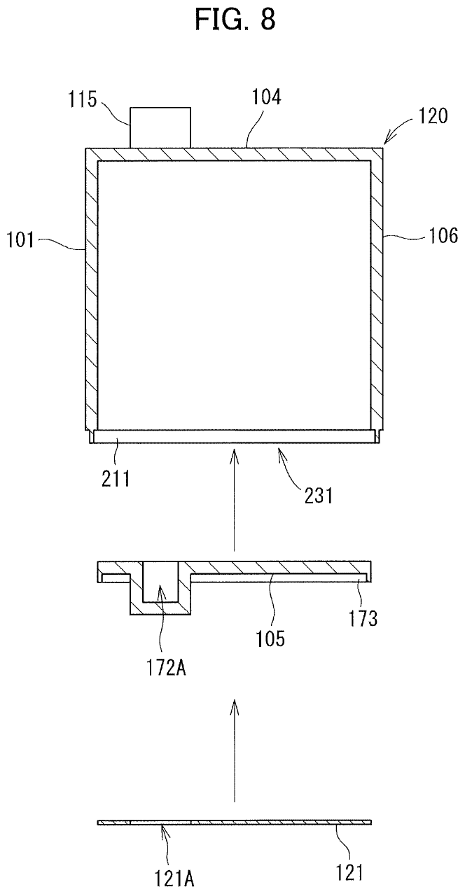

As shown in FIGS. 6 and 8, the bottom wall rib 173 is positioned on the outer edge of the bottom surface of the bottom plate 171. The bottom wall rib 173 protrudes slightly downward from the bottom surface of the bottom plate 171. The bottom wall rib 173 is formed continuously along the outer edge of the bottom surface of the bottom plate 171. The bottom wall rib 173 has an annular shape. The bottom wall rib 173 faces the outer rib 212, right inner rib 213B, and rear inner rib 213A of the main body rib 211 along the entire periphery. The bottom wall rib 173 is slightly spaced apart from the outer rib 212, the right inner rib 213B, and the rear inner rib 213A.

The upper plate 174 is positioned further upward than the bottom plate 171. The upper plate 174 includes a pair of vertical plates 174A and a horizontal plate 174B. One of the pair of vertical plates 174A is positioned at the front end portion of the top surface of the bottom plate 171 in the front-rear direction and the other of the pair of vertical plates 174A is positioned at the rear end portion of the top surface of the bottom plate 171. The pair of vertical plates 174A extend upward from the top surface of the bottom plate 171. Each of the pair of vertical plates 174A has a flat plate shape extending in the up-down and left-right directions. The horizontal plate 174B is positioned on the tops of the pair of vertical plates 174A. Specifically, the horizontal plate 174B is connected to the tops of the pair of vertical plates 174A. The horizontal plate 174B has a flat plate shape extending in the front-rear and left-right directions. The front edge of the horizontal plate 174B is connected to one of the pair of vertical plates 174A. The rear edge of the horizontal plate 174B is connected to the other of the pair of vertical plates 174A. The horizontal plate 174B includes a through-hole 175 extending through the horizontal plate 174B in the up-down direction. The through hole 175 is positioned slightly frontward than the front-rear center of the horizontal plate 174B. The through-hole 175 faces the protruding space 172A in the up-down direction. The horizontal plate 174B is an example of the flat plate portion.

The first bottom wall 151 has the same structure as the fourth bottom wall 154, except the external shape of the first bottom wall 151. Accordingly, elements of the first bottom wall 151 that correspond to those of the fourth bottom wall 154 are designated with the same reference numerals as those used for the fourth bottom wall 154, and descriptions of the elements of the first bottom wall 151 are omitted. The top surface of the first bottom wall 151 is in contact with the bottom edges of front wall 101, left wall 103, and partition wall 134 along the entire periphery. The bottom wall 151 is in contact with the entire periphery of the opening 231A. Accordingly, the first bottom wall 151 covers the entire opening 231A through which the interior and exterior of the ink chamber 111A are in communication with each other. In this state, the top surface of the first bottom wall 151 is in contact with the four left outer protruding walls 236. The bottom wall rib 173 of the first bottom wall 151 faces the outer rib 212, left inner rib 213D, and rear inner rib 213A along the entire periphery. The bottom wall rib 173 of the first bottom wall 151 is slightly spaced apart from the outer rib 212, the left inner rib 213D, and the rear inner rib 213A. The first bottom wall 151 is an example of the cover.

The second bottom wall 152 has the same structure as the fourth bottom wall 154, except the external shape of the second bottom wall 152. Accordingly, elements of the second bottom wall 152 that correspond to those of the fourth bottom wall 154 are designated with the same reference numerals as those used for the fourth bottom wall 154, and descriptions of the elements of the second bottom wall 152 are omitted. The top surface of the second bottom wall 152 is in contact with the bottom edges of front wall 101, partition wall 131, partition wall 132, and partition wall 134 along the entire periphery. In other words, the second bottom wall 152 is in contact with the entire periphery of the opening 231B. Accordingly, the second bottom wall 152 covers the entire opening 231B through which the interior and exterior of the ink chamber 111B are in communication with each other. In this state, the top surface of the second bottom wall 152 is in contact with the three left inner protruding walls 240. The bottom wall rib 173 of the second bottom wall 152 faces the outer rib 212, left inner rib 213D, center inner rib 213C, and rear inner rib 213A along the entire periphery. The bottom wall rib 173 of the second bottom wall 152 is slightly spaced apart from the outer rib 212, the left inner rib 213D, the center inner rib 213C, and the rear inner rib 213A. The second bottom wall 152 is an example of the cover.

The third bottom wall 153 has the same structure as the fourth bottom wall 154. Accordingly, elements of the third bottom wall 153 that correspond to those of fourth bottom wall 154 are designated with the same reference numerals as those used for the fourth bottom wall 154, and descriptions of the elements of the third bottom wall 153 are omitted. The top surface of the third bottom wall 153 is in contact with the bottom edges of the front wall 101, partition wall 132, partition wall 133, and partition wall 134 along the entire periphery. In other words, the third bottom wall 153 is in contact with the entire periphery of the opening 231C. Accordingly, the third bottom wall 153 covers the entire opening 231C through which the interior and exterior of the ink chamber 111C are in communication with each other. In this state, the top surface of the third bottom wall 153 is in contact with the three center inner protruding walls 239. The bottom wall rib 173 of the third bottom wall 153 faces the outer rib 212, center inner rib 213C, right inner rib 213B, and rear inner rib 213A along the entire periphery. The bottom wall rib 173 of the third bottom wall 153 is slightly spaced apart from the outer rib 212, the center inner rib 213C, the right inner rib 213B, and the rear inner rib 213A. The third bottom wall 153 is an example of the cover.

As shown in FIGS. 9, 10, and 13, a front housing section 225 and a rear housing section 226 are positioned further rearward than the protruding space 172A of the fourth bottom wall 154. The rear housing section 226 is positioned further rearward than the front housing section 225 at an interval therebetween. The rear housing section 226 faces the front housing section 225 in the front-rear direction. The front housing section 225 defines a front housing space 225A due to a portion of the bottom plate 171 of the fourth bottom wall 154 protruding upward. The rear housing section 226 defines a rear housing space 226A due to a portion of the bottom plate 171 of the fourth bottom wall 154 protruding upward. Each of the front housing space 225A and the rear housing space 226A has a generally cuboid shape. Each of the front housing section 225 and the rear housing section 226 opens downward. The front housing section 225 and the rear housing section 226 are each an example of the liquid detector.

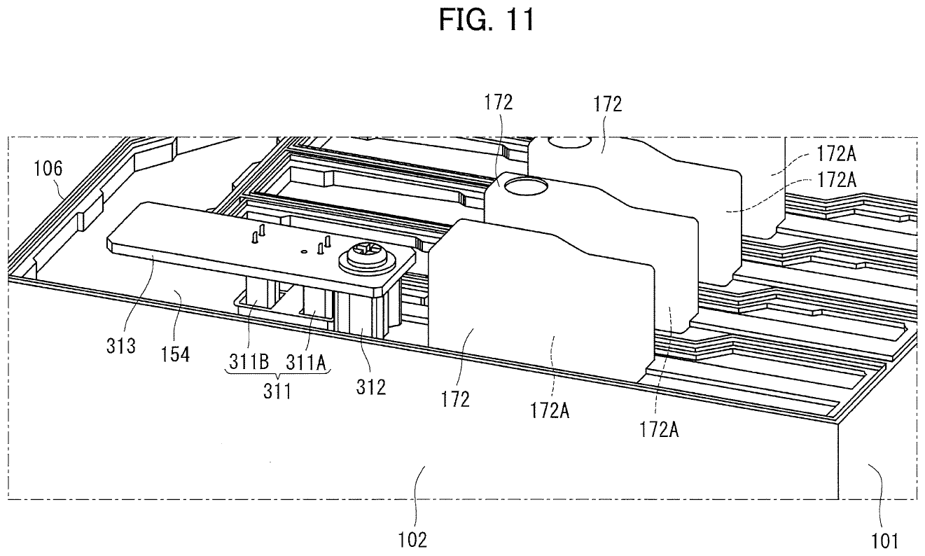

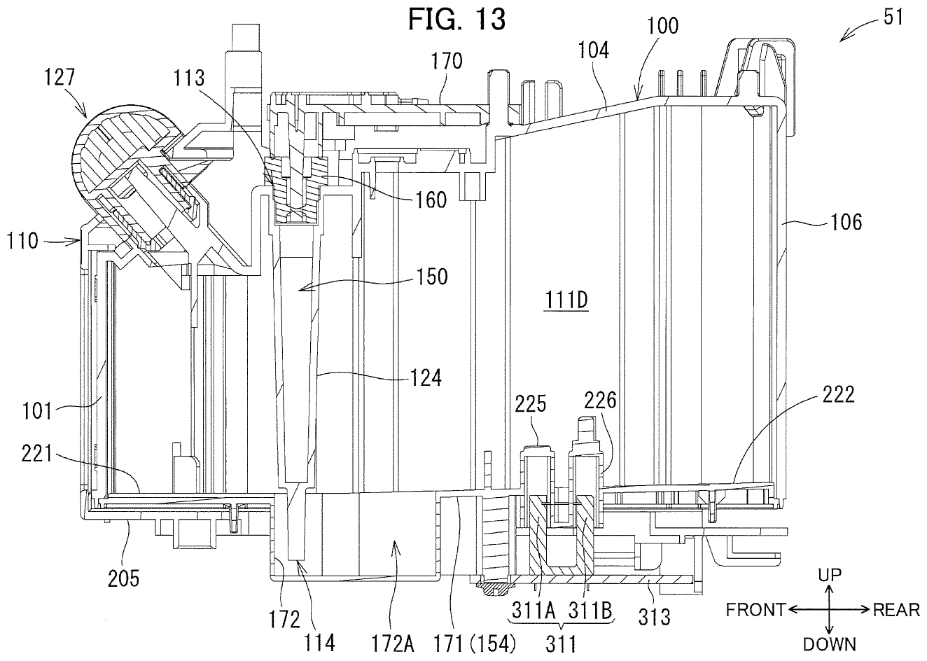

As shown in FIGS. 11 and 13, a sensor 311 is positioned further rearward than the protruding portion 172 of the fourth bottom wall 154. The sensor 311 is configured to detect the level of ink stored in the ink chamber 111D. The sensor 311 includes a light-emitting element 311A and a light-receiving element 311B. The light-emitting element 311A is arrange in the front housing space 225A by being inserted into the front housing space 225A from below the fourth bottom wall 154. The light-receiving element 311B is arranged in the rear housing space 226A by being inserted into the rear housing space 226A from below the fourth bottom wall 154.

Both the light-emitting element 311A and the light-receiving element 311B are fixed to a circuit board 313. The circuit board 313 has a flat plate shape extending in the front-rear and left-right directions. The circuit board 313 is fixed to a protruding portion 312 by bolt and nut. The protruding portion 312 protrudes downward from the bottom surface of the fourth bottom wall 154. Accordingly, the light-emitting element 311A and the light-receiving element 311B are held by the front housing space 225A and the rear housing space 226A, respectively.

The light-emitting element 311A emits light rearward towards the light-receiving element 311B. When the level of ink in the ink chamber 111D is positioned further upward than the path of light emitted from the light-emitting element 311A toward the light-receiving element 311B, the light emitted from the light-emitting element 311A passes through the rear wall of the front housing section 225 in the rearward direction, and then is absorbed by the ink. Hence, the light emitted from the light-emitting element 311A does not reach the front wall of the rear housing section 226. On the other hand, when the level of ink in the ink chamber 111D is positioned further downward than the path of light emitted from the light-emitting element 311A to the light-receiving element 311B, the light emitted from the light-emitting element 311A reaches the front wall of the rear housing section 226. Hence, the light that has reached the front wall of rear housing section 226 passes through the front wall of the rear housing section 226 in the rearward direction, and then is received by the light-receiving element 311B.

The light-receiving element 311B is configured to receive light emitted from the light-emitting element 311A. Upon receiving the light emitted from the light-emitting element 311A, the light-receiving element 311B outputs a detection signal to the circuit board 313. While the light-receiving element 311B does not receive the light emitted from the light-emitting element 311A, the light-receiving element 311B outputs a non-detection signal to the circuit board 313. The non-detection signal has a different level than the level the detection signal. The light-emitting element 311A and the light-receiving element 311B are each an example of the liquid detector. The sensor 311 is an example of the liquid detector.

As shown in FIG. 8, the film 121 is positioned on the bottom surface of the bottom wall 105. The outer edge of the film 121 has a substantially square shape along the outer edge of the bottom of the tank main body 120. The film 121 has four through-holes 121A. Each of the four protruding portions 172 is inserted through the corresponding one of the four through-holes 121A. The film 121 further has a through-hole, through which the circuit board 313 is inserted. The film 121 covers the entire bottom surface of the bottom wall 105 from below, except the four protruding portions 172 and the circuit board 313.

The film 121 is formed of a resin capable of being welded. The film 121 is made of polyethylene terephthalate (PET), for example. The film 121 is welded to the entire main body rib 211 and the entire bottom wall rib 173. Accordingly, the bottom wall 105 is fixed to the tank main body 120. As a result, the likelihood of ink leaking from the ink chamber 111 through a gap between the main body rib 211 and bottom wall rib 173 can be reduced.

As shown in FIG. 5, the top surface of the top wall 104 includes a plurality of surfaces extending in the front-rear and left-right directions. The top wall 104 has four atmospheric communication portions 155 corresponding to the four ink chambers 111A, 111B, 111C, and 111D. The interior and exterior of each of the ink chambers 111A, 111B, 111C, and 111D are in communication with each other through the corresponding one of the atmospheric communication portions 155. Each of the atmospheric communication portions 155 has an atmospheric communication port 112, a semipermeable membrane 156, a labyrinth 157. A film 158 covers the atmospheric communication portions 155.

Each atmospheric communication port 112 extends through the top wall 104 in the up-down direction. The interior and exterior of each of the ink chambers 111A, 111B, 111C, and 111D are in communication with each other through the corresponding one of the atmospheric communication ports 112. Each semipermeable membrane 156 covers the corresponding one of the atmospheric communication ports 112. Each semipermeable membrane 156 is affixed to the top of the corresponding one of the atmospheric communication ports 112 in a state where the semipermeable membrane 156 covers the entirety of the corresponding one of the atmospheric communication ports 112 from above. Each semipermeable membrane 156 is a porous membrane having micropores that allow air to pass therethrough while blocking ink from passing therethrough. For example, the semipermeable membranes 156 are made of fluoropolymer such as polytetrafluoroethylene.

Each labyrinth 157 is positioned further rearward than the corresponding one of the atmospheric communication ports 112. Each labyrinth 157 has a groove shape that is recessed downward from the top surface of the top wall 104. Each labyrinth 157 has portions extending in the front-rear direction. Each labyrinth 157 has at least two U-turns (hairpin turns) in the front-rear direction. Specifically, each labyrinth 157 has five or more U-turns (hairpin turns) in the front-rear direction.

The film 158 is welded to the top surface of the top wall 104 in a state where the film 158 covers the four atmospheric communication ports 112 and the four labyrinths 157 from above. The film 158 has four atmospheric vents 158A each of which corresponds to one of the labyrinths 157. The interior and exterior of each labyrinth 157 are in communication with each other through the corresponding one of the atmospheric vents 158A. The four atmospheric vents 158A are arranged at intervals in the left-right direction. Four front spaces are defined by the film 158 and the parts of top wall 104 defining the atmospheric communication ports 112. Four rear spaces are defined by the film 158 and the labyrinths 157. Each front space and the corresponding one of the rear spaces are in communication with each other.

The interior of each of the ink chambers 111A, 111B, 111C, and 111D is in communication with atmosphere through the corresponding one of the atmospheric communication ports 112, the corresponding one of the semipermeable membranes 156, the corresponding one of the front spaces, the corresponding one of the rear spaces, and the corresponding one of the atmospheric vents 158A. As a result, each atmospheric communication portion 155 allows air to flow between the interior of the corresponding one of the ink chambers 111A, 111B, 111C, and 111D and the exterior of the ink tank 100.

Each rear space has a cross-sectional area taken along a plane orthogonal to the front-rear direction in which the corresponding one of the labyrinths 157 extends. Each cross-sectional area is one square millimeter, for example. Accordingly, even in a state where the semipermeable membranes 156 are not present at the top of the atmospheric communication ports 112, the rear spaces defined by the film 158 and the labyrinths 157 can reduce the likelihood of ink evaporating or leaking out through the atmospheric vents 158A.

The thickness of the bottom wall 105, that is, the thickness of the bottom plate 171 of the bottom wall 105, is greater than the thickness of the films welded to the ink tank 100, such as the film 121 and the film 158. As a result, the strength of the bottom wall 105 can be easily made greater than the strength of the films. In other words, the bottom wall 105 is less likely to be damaged and deformed than the films. The thickness of the film 121 and the film 158 is 0.1 mm, for example. The thickness of the bottom wall 105 is 1.2 mm, for example. Incidentally, the thickness of the film 121 may be either greater than or less than the thickness of the film 158. The film 121 is an example of the film. The film 158 is an example of the film.

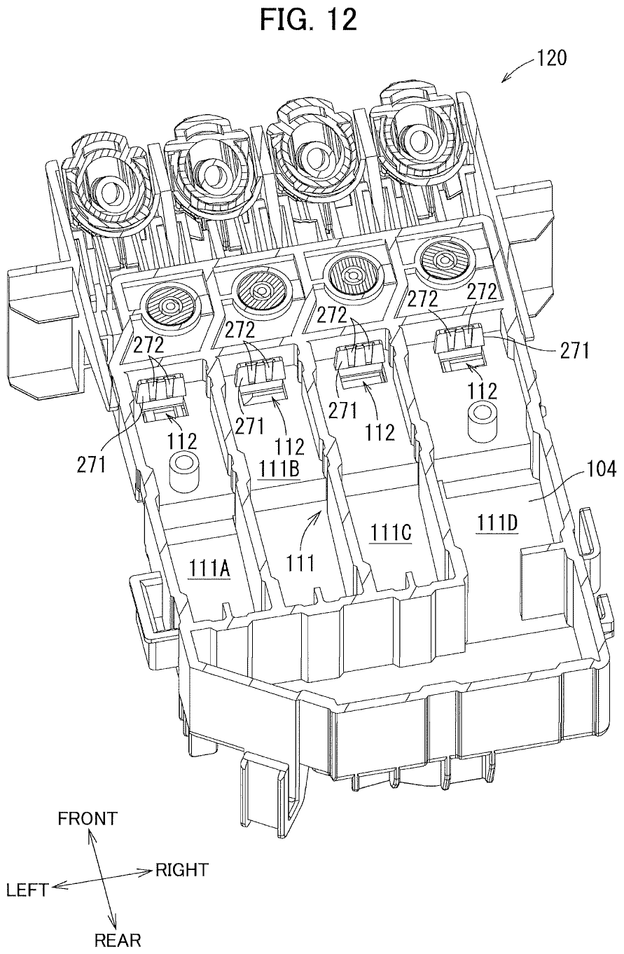

As shown in FIG. 12, four protruding pieces 271 are provided. Each protruding piece 271 protrudes downward from the peripheral portion of the corresponding one of the atmospheric communication ports 112 on the inner surface of the top wall 104. Each protruding piece 271 is positioned further frontward than the corresponding one of the atmospheric communication ports 112. Each protruding piece 271 has a flat plate shape extending in the up-down and left-right directions. The length of each protruding piece 271 in the left-right direction is slightly greater than the length of the corresponding one of the atmospheric communication ports 112 in the left-right direction. Each protruding piece 271 has two grooves 272 positioned at the rear surface of the protruding piece 271. In each protruding piece 271, the two grooves 272 are recessed frontward from the rear surface of the protruding piece 271. The two grooves 272 are spaced apart from each other in the left-right direction. The grooves 272 extend from the top of the protruding piece 271 to the bottom of the protruding piece 271. The bottom edges of the grooves 272 open downward. The protruding pieces 271 are each an example of the second protruding portion.

As shown in FIG. 5, the top surface of the top wall 104 further has a sloped surface 104A and a horizontal surface 104B. The sloped surface 104A is positioned at the front end portion of the top surface of the top wall 104. The sloped surface 104A is sloped relative to the front-rear direction so as to diagonally extend in the frontward direction and in the downward direction. The sloped surface 104A extends from the left edge to right edge of the ink tank 100. The horizontal surface 104B is positioned further rearward than the sloped surface 104A. The horizontal surface 104B extends in the horizontal directions. The horizontal surface 104B extends from the left edge and right edge of the ink tank 100.

Four openings 113 are provided. Each of the opening 113 is positioned between the horizontal surface 104B and the corresponding one of the atmospheric communication ports 112 in the front-rear direction. The four openings 113 are arranged at equal intervals in the left-right direction. The interior and exterior of each of the ink chambers 111A, 111B, 111C, and 111D are in communication with each other through the corresponding one of the openings 113.

As shown in FIGS. 5, 6, and 13, four outflow tube 124 are provided. Each outflow tube 12 is connected to the corresponding one of the openings 113. Each outflow tube 124 is a circular tube that extends downward from the corresponding one of the openings 113 in the up-down direction. Each outflow tube 124 has an outflow port 114 at the bottom end of the outflow tube 124. The outflow ports 114 open downward. Each outflow tube 124 defines an outflow path 150. The outflow path 150 extends in the up-down direction from the corresponding one of the outflow ports 114 to the corresponding one of the openings 113 through the corresponding one of the through-holes 175 of the horizontal plate 174B. Each outflow port 114 is positioned in the corresponding one of the protruding spaces 172A. Each outflow port 114 is spaced apart from the inner surface of the corresponding protruding space 172A. Each outflow port 114 is positioned further downward than the up-down center of the corresponding protruding space 172A. Each outflow port 114 is positioned slightly upward than the bottom of the corresponding protruding space 172A.

Four sealing members 160 which is made of rubber are provided. Each sealing member 160 is press-fitted into the corresponding one of the outflow tubes 124 through the corresponding opening 113. Each sealing member 160 has a through-hole extending in the up-down direction.

As shown in FIG. 6, each outflow tube 124 is connected to a connecting portion 170 arranged at the top surface of the top wall 104. The connecting portion 170 is connected to the four outflow tubes 124 via the sealing members 160. The connecting portion 170 has four ink channels 191. Each ink channel 191 is in communication with the outflow path 150 of the corresponding one of the outflow tubes 124. The top portion of each of the four ink channels 191 is covered by a film. Note that the film has been omitted in FIG. 6. Each of the ink channels 191 is connected to the corresponding one of the ink tubes 32, which are connected to the recording head 39. As a result, ink stored in each of the ink chambers 111A, 111B, 111C, and 111D flows to the recording head 39 through the corresponding outflow tube 124, the corresponding ink channel 191, and the corresponding ink tube 32. As ink is consumed from the ink chambers 111A, 111B, 111C, and 111D by ink being ejected from the recording head 39, air flows into the ink chambers 111A, 111B, 111C, and 111D through the corresponding atmospheric communication ports 112.

As shown in FIG. 5, the tank main body 120 has four tank tubes 115, four communication ports 119, and four tubular annular walls 122. The four tank tubes 115, the four communication ports 119, and the four annular walls 122 are positioned at the front end portion of the top wall 104. Each of the four annular walls 122 surrounds the corresponding one of the communication ports 119 and the corresponding one of the tank tubes 115. The four annular walls 122 are arranged at equal intervals in the left-right direction. Each annular wall 122 extends from the front end portion of the top wall 104 in an extending direction crossing both the vertical direction and the horizontal direction. Specifically, each annular walls 122 extends diagonally upward and frontward and parallel to the extending direction of the corresponding tank tube 115. Each tank tube 115 protrudes further upward than the distal edge of the corresponding annular wall 122.

Each of the tank tubes 115 is positioned inward of the corresponding one of the annular walls 122. Each of the tank tubes 115 is positioned further rearward than the circular center of the corresponding one of the annular walls 122. In other words, the center axis of each of the tank tubes 115 is positioned further rearward than the center axis of the corresponding annular wall 122 when viewed in the extending direction in which the tank tubes 115 extend. The center axis of the tank tube 115 passes through the circular center of the tank tube 115 and the center axis of the annular wall 122 passes through the circular center of the annular wall 122. Each tank tube 115 is a circular tube extending from the top wall 104 in the extending direction, which crosses both the vertical direction and the horizontal direction. Specifically, each tank tube 115 extends diagonally upward and forward. Each tank tube 115 provides communication between the interior and exterior of the corresponding one of the ink chambers 111A, 111B, 111C, and 111D. The top ends of the tank tubes 115 open upward. The top end of each of the tank tubes 115 is divided in the left-right direction into two lip portions. Therefore, a gap is formed at each of the top and bottom portions of the distal edge of each tank tube 115. The bottom ends of the tank tubes 115 open downward.

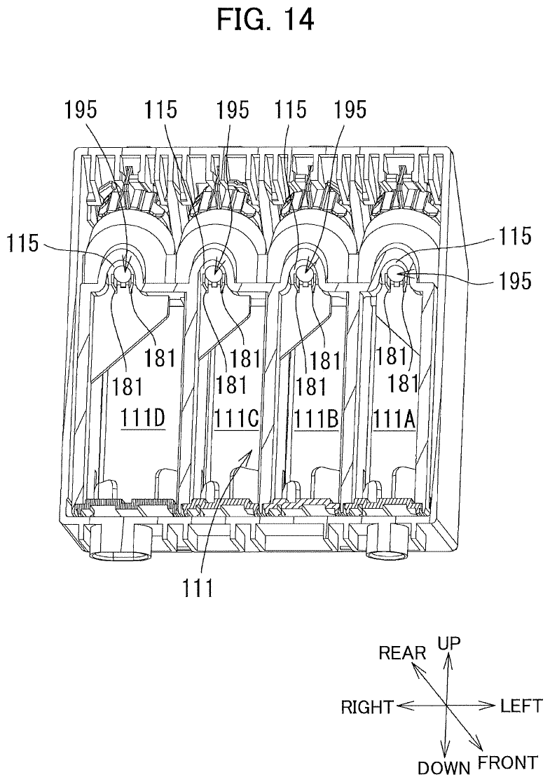

As shown in FIG. 14, each tank tube 115 has two protruding pieces 181 extending downward from the bottom edge of the tank tube 115. One of the two protruding pieces 181 is positioned at the left portion of the bottom edge of the tank tube 115 and the other of the two protruding pieces 181 is positioned at the right portion of the bottom edge of the tank tube 115. Each protruding piece 181 has a flat plate shape extending in the up-down and front-rear directions. The protruding pieces 181 are each an example of the first protruding piece.

As shown in FIG. 5, each of the communication ports 119 is positioned inside the corresponding annular wall 122 on the sloped surface 104A. The communication ports 119 extend through the top wall 104 in the up-down direction. The front portion of the communication port 119 has a circular shape and the rear portion of the communication port 119 has a rectangular shape. In other words, the communication ports 119 have a quadrilateral shape whose front side curves outward in an arc shape. The interior and exterior of each of the ink chambers 111A, 111B, 111C, and 111D are in communication with each other through the corresponding one of the communication ports 119. Each of the communication ports 119 is positioned further frontward than the corresponding tank tube 115. Each of the communication ports 119 is positioned further downward than the corresponding tank tube 115. In other words, regarding each communication port 119, a straight line extending in the extension direction of the corresponding tank tube 115 and passing through the center of the communication port 119 when viewed in the extension direction of the tank tube 115, is positioned frontward than a straight line passing through the center of the tank tube 115 when viewed in the extension direction of the tank tube 115. Each of the communication ports 119 is positioned further frontward than the circular center of the corresponding annular wall 122. In other words, regarding each communication port 119, a straight line extending in the extending direction of the corresponding annular wall 122 and passing through the center of the communication port 119 when viewed in the extension direction of the annular wall 122, is positioned frontward than a straight line passing through the center of the annular wall 122 when viewed in the extension direction of the annular wall 122.

As shown in FIG. 4, the tank cover 110 holds the ink tank 100 in a state where the tank cover 110 covers the front portion of the ink tank 100. The tank cover 110 includes a front wall 201, a top wall 202, a right wall 203, a left wall 204, a bottom wall 205, and a sloped wall 206. The front wall 201 covers the front side of the ink tank 100. The front wall 201 has an opening 207. A portion of the front wall 101 of the ink tank 100 is exposed in the frontward direction through the opening 207. Here, “A portion of the front wall 101 of the ink tank 100 is exposed in the frontward direction through the opening 207” signifies that a user can see at least portion of the front wall 101 from the front through the opening 207, and does not signify that a portion of the front wall 101 protrudes frontward through the opening 207. Incidentally, the tank cover 110 may have a translucent cover covering the opening 207 in a state where the front wall 101 of the ink tank 100 is visible through the translucent cover from the front.

The top wall 202 covers part of the front portion of the top wall 104 of the ink tank 100. The right wall 203 covers part of the right wall 102 of the ink tank 100. The left wall 204 covers part of the left wall 103 of the ink tank 100. The bottom wall 205 covers part of the bottom wall 105 of the ink tank 100. The bottom wall 205 is an example of the cover portion. The tank cover 110 is an example of the tank cover.

The sloped wall 206 is connected to the top edge of the front wall 201 and is connected to the front edge of the top wall 202. Part of the sloped wall 206 is positioned further upward than the four annular walls 122 of the ink tank 100. Part of the sloped wall 206 is positioned further frontward than the four annular walls 122 of the ink tank 100. In other words, the sloped wall 206 is positioned further in the extension direction of the annular wall 122 relative to the annular walls 122. The outer surface of the sloped wall 206 crosses both the vertical direction and the horizontal direction. The outer surface of the sloped wall 206 slopes relative to the front-rear direction so as to diagonally extend in the frontward and in the downward direction. The sloped wall 206 covers part of the sloped surface 104A of the top wall 104 of the ink tank 100. The sloped wall 206 is slightly spaced apart from the sloped surface 104A in the extension direction.

The sloped wall 206 has four through-holes 72 which are arranged at intervals in the left-right direction. Each through-hole 72 extends through the sloped wall 206 in the up-down direction. The sloped wall 206 has an inner peripheral surface defining the four through-holes 72. Hereinafter, the inner peripheral surface defining the through-hole 72 will be called the “inner peripheral surface of the through-hole 72”. The inner peripheral surface of each of the through-holes 72 has a tubular shape extending in a direction orthogonal to the outer surface of the sloped wall 206, i.e., extending diagonally upward and forward. In other words, each of the through-holes 72 has a tubular shape. Here, a tubular shape denotes the shape of an inner peripheral surface that surrounds an area to form an enclosed space. Thus, the shape of an opening defined by the inner peripheral surface does not necessarily have a circular shape. Furthermore, the inner peripheral surface is regarded as having a tubular shape regardless of the length in which the inner peripheral surface extends in a direction in which the opening defined by the inner peripheral surface faces, i.e., regardless of the thickness of that through-hole 72. The inner peripheral surface of each through-hole 72 surrounds the corresponding annular wall 122 when viewed from a diagonally upward and forward perspective. Each of the four through-holes 72 is positioned so as to correspond to a respective one of the four ink chambers 111A, 111B, 111C, and 111D. That is, each of the four through-holes 72 overlaps the corresponding one of the four ink chambers 111A, 111B, 111C, and 111D when viewed from a diagonally upward and forward perspective. Each annular walls 122 and each communication port 119 are exposed to the outside of the tank cover 110 through the corresponding through-hole 72. Each tank tube 115 protrudes to the outside of the tank cover 110 through the corresponding through-hole 72. Each tank tube 115 and each communication port 119 are visible through the corresponding through-hole 72.

The front portion of the through-hole 72 is circular and the rear portion of the through-hole 72 is rectangular. In other words, each of the through-holes 72 has a quadrilateral shape whose front side curves outward in an arc shape. Each through-hole 72 has a shape allowing a protrusion 94 of a bottle cap 82 of an ink bottle 80 described later to be inserted into the through-hole 72. The shape of the inner peripheral surface of each through-hole 72 is approximately equivalent to the shape of the outer circumferential surface of the protrusion 94. As a result, the inner peripheral surfaces of each through-hole 72 fixes the corresponding bottle cap 82 in position in a state where the bottle cap 82 is inserted into the through-hole 72. The inner peripheral surface of each through-hole 72 are each an example of the positioning part. A slit 73 extends rearward from the through-hole 72. The slit 73 is positioned in the left-right center of the through-hole 72. The slit 73 is continuous with the through-hole 72.

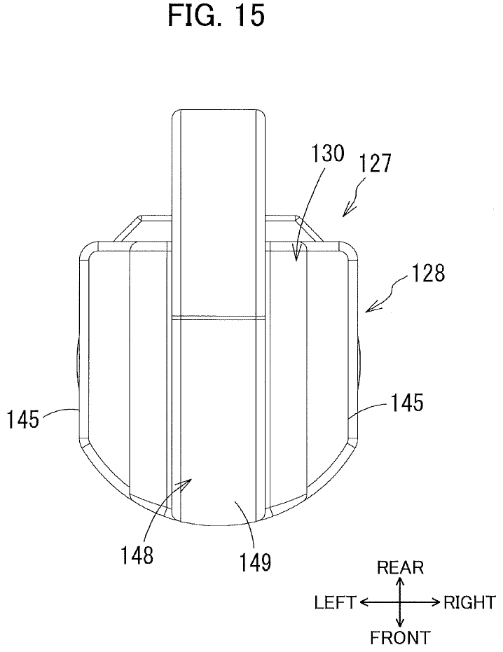

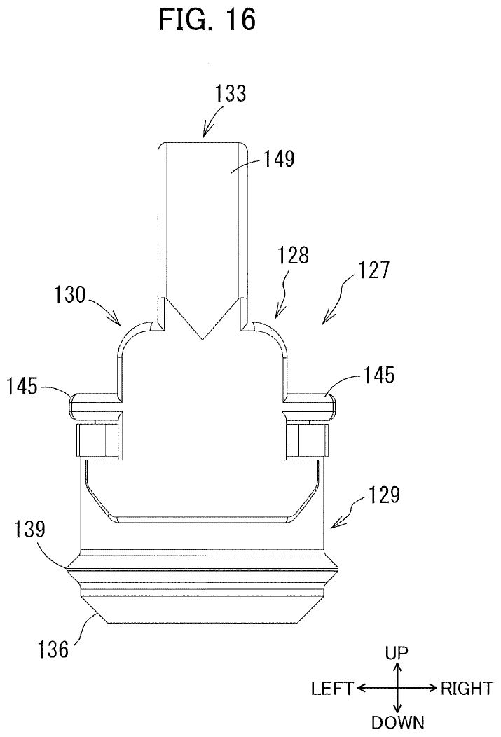

As shown in FIGS. 15 through 20, each of the tank caps 127 is a cylindrical member with one end of the tank cap 127 closed. Each of the tank caps 127 is attachable to and detachable from the corresponding annular wall 122. In a state where the tank cap 127 is detached from the annular wall 122, the tank cap 127 is no longer connected to the ink tank 100 and tank cover 110 and is completely separated therefrom. That is, the ink tank set 51 does not include any retaining members that include arms for holding the tank caps 127 detached from the corresponding annular walls 122 with the detached tank caps 127 connected to the ink tank 100 or tank cover 110.

Each of tank caps 127 includes a body 128 and a rubber portion 129. The body 128 is molded of synthetic resin. The rubber portion 129 is made of rubber. The body 128 has a tubular portion 130, two protruding pieces 145, a flat plate portion 146, and a knob portion 148.

The tank cap 127 is in an attached orientation in a state where the tank cap 127 is attached to the corresponding annular wall 122. The tubular portion 130 has a cylindrical shape opening downward in the attached orientation. The internal space of the tubular portion 130 has an inner diameter greater than the outer diameter of the tank tube 115.

In a state where the tank cap 127 is in the attached orientation, one protruding piece 145 protrudes leftward from the outer peripheral surface of the tubular portion 130 and the other protruding piece 145 protrudes rightward from the outer peripheral surface of the tubular portion 130. That is, the pair of protruding pieces 145 protrude in opposite directions from the outer peripheral surface of the tubular portion 130. Each of the protruding pieces 145 has a flat plate shape. Each of the protruding pieces 145 has a protruding edge that is linearly shaped in the front-rear direction in a state where the tank cap 127 is in the attached orientation.

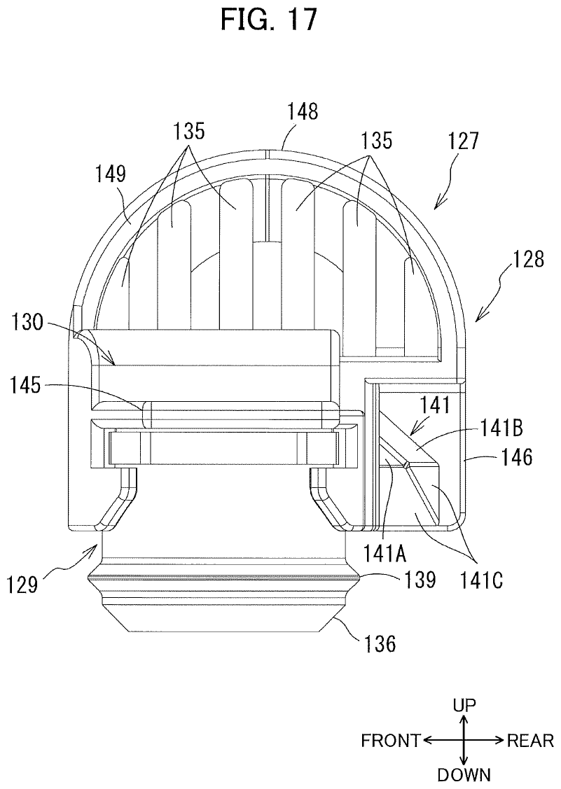

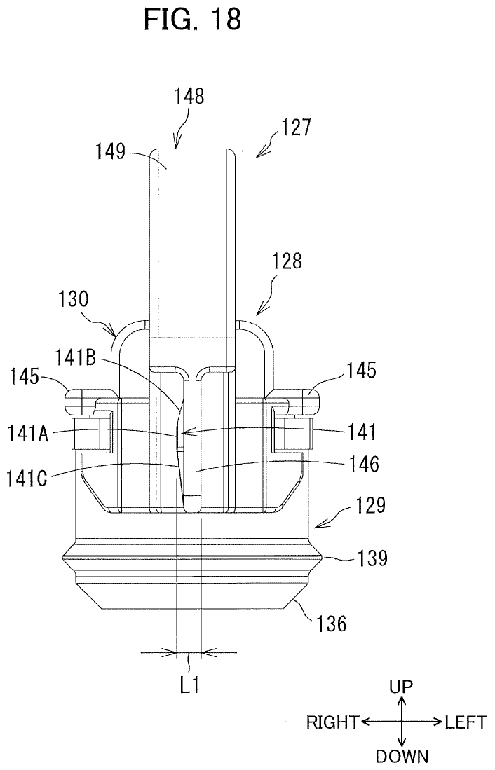

As shown in FIGS. 17 and 18, the flat plate portion 146 protrudes rearward from the outer peripheral surface of the tubular portion 130 in a state where the tank cap 127 is in the attached orientation. The flat plane portion 146 has a generally flat plate shape extending in the up-down and front-rear directions. The flat plate portion 146 has a bulged part 141 expanding rightward from the right surface of the flat plate portion146. The outer surface of the bulged part 141 has a vertical surface 141A, a top sloped surface 141B, and a bottom sloped surface 141C. The vertical surface 141A is positioned at the approximate up-down center of the right surface of the flat plate portion 146. The vertical surface 141A is positioned at the front end of the right surface of the flat plate portion 146. The vertical surface 141A is a vertical surface extending in the front-rear and up-down directions. The vertical surface 141A has a right triangle shape when viewed from a rightward perspective. The top sloped surface 141B is positioned further upward and rearward than the vertical surface 141A. The top sloped surface 141B extends upward from the hypotenuse of the vertical surface 141A. The top sloped surface 141B slopes relative to the vertical surface 141A so as to diagonally extends in the leftward direction and in the upward direction. The bottom sloped surface 141C is positioned further downward than the vertical surface 141A and the top sloped surface 141B. The bottom sloped surface 141C extends downward from the bottom edges of the vertical surface 141A and the top sloped surface 141B. The bottom sloped surface 141C slopes relative to the vertical surface 141A so as to diagonally extend in the downward direction and in the leftward direction.

A length L1 between the left surface of the flat plate portion 146 and the vertical surface 141A of the flat plate portion 146 in the left-right direction is slightly greater than the length of the slit 73 of the tank cover 110 in the left-right direction. Accordingly, since the flat plate portion 146 is fitted into the slit 73 from above, both the vertical surface 141A and the left surface of the flat plate portion 146 press the inner surface of the slit 73 outward in the left-right direction. As a result, the likelihood of the tank cap 127 being accidentally detached from the through-hole 72 of the tank cover 110 can be reduced.

The knob portion 148 is positioned further upward than the tubular portion 130 and flat plate portion 146. The knob portion 148 has a semicircular plate shape that protrudes upward from the tubular portion 130 and flat plate portion 146. The diameter of the semicircular plate shape is approximately the same as the total length of both the tubular portion 130 in the front-rear direction and the flat plate portion 146 in the front-rear direction. Hence, the knob portion 148 has a slender shape that extends across the tubular portion 130 and flat plate portion 146 in the front-rear direction and extends in the left-right direction, the length of the knob portion 148 in the left-right direction being shorter than the length of the knob portion 148 in the front-rear direction.

The edge of the knob portion 148 that constitutes the circumference of the semicircular plate shape is a thick-walled portion 149 extending in the left-right direction. The knob portion 148 includes a plurality of ridges 135. Each of the ridges 135 extends from the bottom edge of the knob portion 148 toward the thick-walled portion 149 in the up-down direction. The ridges 135 are arranged at intervals in the front-rear direction. Each of the ridges 135 has a length in the left-right direction gradually increasing from the bottom edge of the knob portion 148 toward the thick-walled portion 149. Near the thick-walled portion 149, the length of the ridge 135 in the left-right direction is the same as the length of the thick-walled portion 149 in the left-right direction. The remaining portion of the knob portion 148, excluding the thick-walled portion 149 and the ridges 135, has a length in the left-right direction that is smaller than the length of the thick-walled portion 149 in the left-right direction.

The rubber portion 129 is positioned at the outer peripheral surface of the tubular portion 130. The rubber portion 129 is positioned further downward than the protruding pieces 145. The rubber portion 129 has a cylindrical shape. The rubber portion 129 covers the portion of the outer peripheral surface of the tubular portion 130 that is positioned further downward than the protruding pieces 145. The top edge of the rubber portion 129 is in contact with the protruding pieces 145.

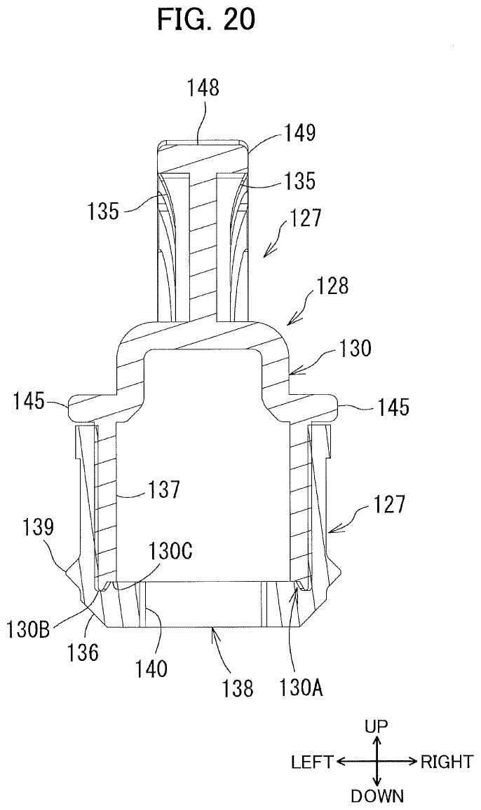

The rubber portion 129 has a contact part 136. The contact part 136 extends inward from the opening of the tubular portion 130. The contact part 136 is in contact with the end face of the opening of the tubular portion 130. Note that the end face of the opening of the tubular portion 130 denotes a bottom surface 130A of the tubular portion 130 in the axial direction (the up-down direction shown in FIG. 20). The bottom surface 130A has a ridge 130B and a surface 130C. The ridge 130B is positioned further outward than the surface 130C in the radial direction of the tubular portion 130. The surface 130C is positioned further inward than the ridge 130B in the radial direction of the tubular portion 130. The ridge 130B protrudes further downward than the surface 130C. Accordingly, the step in the up-down direction is disposed between the ridge 130B and the surface 130C. The contact part 136 is in contact with the ridge 130B and the surface 130C. Incidentally, the contact part 136 may be in contact with an inner peripheral surface 137 of the tubular portion 130 inside the opening of the tubular portion 130.

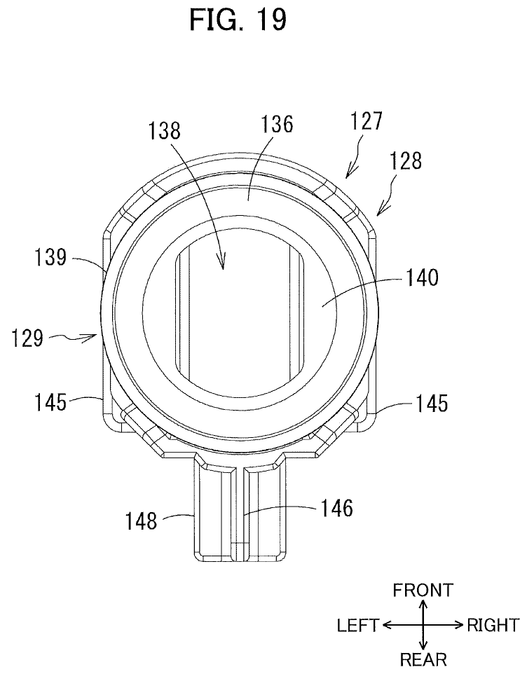

As shown in FIG. 19, two flanges 140 extend from the contact part 136 inward in the radial direction of the tubular portion 130. The contact part 136 and flanges 140 define an opening 138 facing downward. One of the two flanges 140 extends rightward from the right inner edge of the left portion of the contact part 136 and the other of the two flanges 140 extends leftward from the left inner edge of the right portion of the contact part 136. No flanges 140 are provided at the front and rear portions of the contact part 136. The length of the opening 138 in the front-rear direction is longer than the length of the opening 138 in the left-right direction. In other words, the opening 138 has an oblong shape, which is formed by straightening the left portion and the right portion of a circle. The length of the opening 138 in the left-right direction is greater than the outer diameter of the tank tube 115 of the ink tank 100.

The rubber portion 129 has a protruding portion 139 that annularly protrudes from the outer circumferential surface of the rubber portion 129. The outer diameter of the protruding portion 139 is greater than the inner diameter of the corresponding annular wall 122 of the ink tank 100. The rubber portion 129 fixed to the tubular portion 130 is configured to be inserted into the internal space of the annular walls 122 by press-fitting. In a state where the tubular portion 130 and rubber portion 129 are inserted in the internal space of the corresponding annular wall 122, the tubular portion 130 and rubber portion 129 cover the upper portion of the corresponding communication port 119 and the upper portion of the corresponding tank tube 115. In a state where the rubber portion 129 is inserted in the internal space of the corresponding annular wall 122, the protruding portion 139 is in liquid-tight contact with the inner circumferential surface of the annular walls 122.

### <Ink Bottle 80>

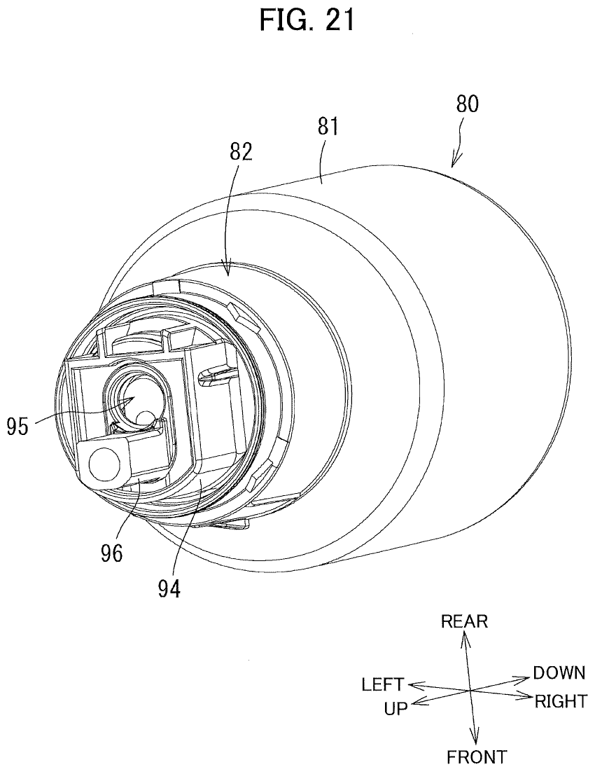

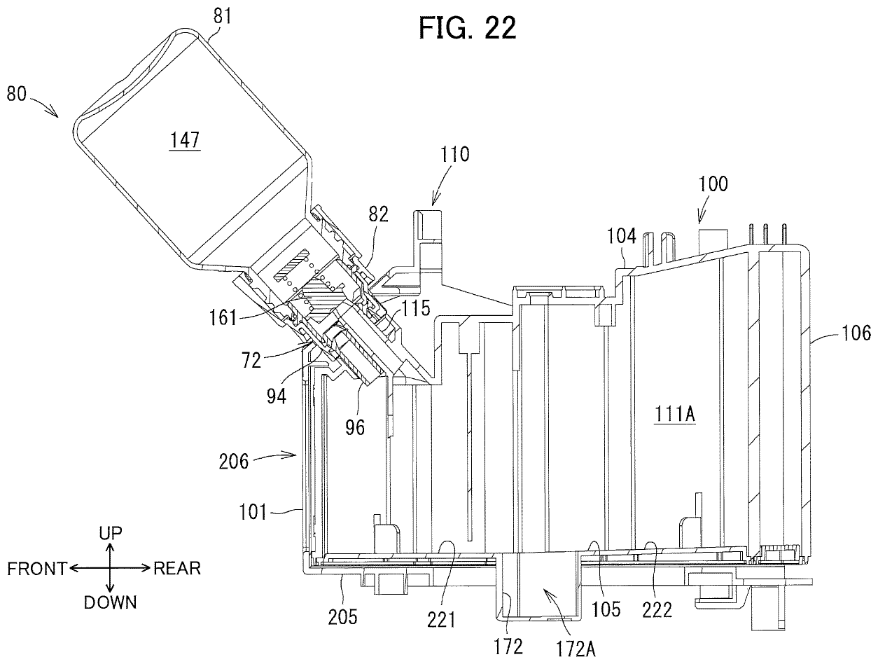

As shown in FIGS. 21 and 22, the ink bottle 80 is configured to be connected to the ink tank set 51. The ink bottle 80 includes a bottle body 81, the bottle cap 82, and a valve 161. The bottle body 81 has a cylindrical shape. The top end portion of the bottle body 81 is open. The bottle body 81 has an ink storage chamber 147 for storing therein toner. The bottle cap 82 has a cylindrical shape. The bottle cap 82 is attachable to and detachable from the top end portion the bottle body 81. The internal space of the bottle cap 82 and the interior of the ink storage chamber 147 are in communication with each other.

The bottle cap 82 has a protrusion 94, an opening 95, and a bottle tube 96. The protrusion 94 a wall having a tubular shape and extending upward. The protrusion 94 is configured to be inserted into the through-hole 72 in the tank cover 110. The shape of the outer circumferential surface of the protrusion 94 is approximately the same as the shape of the inner peripheral surface of the through-hole 72. The opening 95 and the bottle tube 96 are positioned at the top of the protrusion 94. The interior and exterior of the ink bottle 80 are in communication with each other through the opening 95. The bottle tube 96 is positioned further forward than the opening 95. The bottle tube 96 extends upward from the top of the protrusion 94. The interior and exterior of the ink bottle 80 are in communication with each other through the bottle tube 96. The valve 161 is arranged in the internal space of the bottle cap 82. The bottle tube 96 has a top opening and a bottom opening. The top opening opens to the outside of the ink bottle 80. The bottom opening opens to the inside of the ink storage chamber 147. The valve 161 is configured to close the opening 95 and the bottom opening of the bottle tube 96. The valve 161 is movable between a closed position and an open position in the up-down direction shown in FIG. 21. In a state where the valve 161 is at the closed position, the valve 161 closes the opening 95 and the bottom opening of the bottle tube 96. In a state where the valve 161 is at the open position, the valve 161 opens the opening 95 and the bottom opening in the bottle tube 96.

### <Connection Between the Ink Bottle 80 and Ink Tank 100>

The following description is based on an example that describes the process of connection of ink bottle 80 to the ink chamber 111A as shown in FIG. 22. Note that the connecting portion 170 has been omitted in FIG. 22 for simplicity. The user inserts the protrusion 94 of the ink bottle 80 into the through-hole 72 of the tank cover 110. The bottle tube 96 of the ink bottle 80 is connected to the communication port 119 of the ink tank 100, and the tank tube 115 of the ink tank 100 is inserted into the opening 95 of the ink bottle 80. As the tank tube 115 is inserted into the opening 95, the valve 161 is pushed by the tank tube 115 and moves from the closed position to the open position. As a result, the connection between the ink bottle 80 and the ink tank 100 is completed.

After the ink bottle 80 is connected to the ink tank 100, ink stored in the ink storage chamber 147 flows into the ink chamber 111A of the ink tank 100 through the bottle tube 96 and the communication port 119. At the same time, air within the ink chamber 111A flows into the ink storage chamber 147 through the tank tube 115 and the opening 95. As a result, ink stored in the ink bottle 80 is supplied into the ink chamber 111A due to the occurrence of gas-liquid replacement.

Note that, when the ink bottle 80 is connected to the ink tank 100, ink possibly flows into the ink chamber 111A from the ink storage chamber 147 through the inner space of the tank tube 115. In the present embodiment, since the two protruding pieces 181 are provided at the bottom of the tank tube 115 and extends downward therefrom, even if ink adheres to the bottom of the tank tube 115, the ink is likely to fall along the two protruding pieces 181. Accordingly, the formation of an ink meniscus at the opening 195 of the tank tube 115 can be reduced. As a result, the flow of air between the ink chamber 111A and the ink storage chamber 147, and the flow of air between the interior and exterior of the ink chamber 111A can be easily ensured.

### Effects of the Embodiment

In the ink tank 100, since the strength of the bottom wall 105 is greater than the strength of the film, the strength of the ink tank 100 is a greater than the strength of an ink tank in which the entire opening 231 is covered by the film. Accordingly, when the ink tank 100 is attached to the inner surface of the casing 8 of the multifunction peripheral 10, the likelihood of the bottom wall 105 being damaged or deformed can be reduced, even if the bottom wall 105 contacts the inner surface of the casing 8 and any component provided in the multifunction peripheral 10, or receives a load from the ink stored in the ink chamber 111. As a result, the likelihood of ink leaking from the ink tank 100, or the likelihood of the volumetric accuracy of the ink chamber 111 decreasing can be reduced. Also, since the bottom wall 105 covers the opening 231 of the tank main body 120, the use of film for covering the opening 231 can be reduced. Hence, the burden for the environment due to using film can be reduced.

In the ink tank 100, the bottom wall 105 is fixed to the tank main body 120 by welding. Hence, the likelihood of ink stored in the ink chamber 111 leaking through a portion between the main body rib 211 of the tank main body 120 and the bottom wall rib 173 of the bottom wall 105 can be reduced. Note that in the present specification the expression “X is fixed to Y by welding” means that X is fixed to Y either directly by welding or via an intermediate member (e.g. a film) that is welded to both X and Y.

In the ink tank 100, the bottom wall 105 has the protruding part 172 protruding further downward than the bottom surface of the bottom plate 171. Hence, when the ink tank 100 is attached to the inner surface of the casing 8, the bottom surface of the bottom place 171 is less likely to contact the inner surface of the casing 8 or any component provided in the multifunction peripheral 10. As a result, the bottom surface of the bottom plate 171 is less likely to be damaged.

In the ink tank 100, the protruding portion 172 of the bottom wall 105 protrudes downward from the horizontal surface 221 and the sloped surface 222 to define the protruding space 172A which is capable of store therein ink. Hence, when each of the remaining amount of ink stored in the corresponding one of the ink chambers 111A, 111B, 111C, and 111D becomes low, each of the ink is likely to be stored in the corresponding one of the protruding portions 172A. Furthermore, since each outlet port 114 is positioned in the corresponding protruding space 172A, ink stored in each of the ink chambers 111A, 111B, 111C, and 111D can easily flow outside through the corresponding one of the outlet ports 114. As a results, ink can be used up to their maximum extent.

In the ink tank 100, the bottom wall 105 has the horizontal plate 174B which is positioned further upward than both the outflow port 114 and the bottom plate 171. The horizontal plate 174B has a flat plate shape extending in the front-rear and left-right directions. Hence, the constituents of the ink which easily sink to the bottom, is likely to be accumulated on the top surface of the horizontal plate 174B, particularly in a case where the ink is a pigmented ink. As a result, the accumulation of the constituents of the ink in the vicinity of the outflow port 114 in the protruding space 172A can be reduced. The tank main body 120 is molded as a single piece using a die in which a core is pulled out from a cavity in the up-down direction. Hence, the tank main body 120 opens downward. The horizontal plate 174B is provided at the bottom wall 105 fixed to the tank main body 120. Hence, structures that reduce the accumulation of the constituents of the ink, which easily sink to the bottom, in the vicinity of the outflow port 114 in the protruding space 172A can be easily provided.

In the ink tank 100, the bottom wall 105 covers the entirety of the opening 231, which provides a communication between the interior and exterior of the ink chamber 111. In other words, the film 121 is not used for covering the opening 231. Hence, the strength of the ink tank 100 is maximized.

In the ink tank 100, the bottom wall 105 is fixed to the tank main body 120 by the film 121 being welded to the main body rib 211 of the tank main body 120 and the bottom wall rib 173 of the bottom wall 105. Hence, the film 121 fills the gap formed between the bottom wall rib 173 and the main body rib 211 from below. As a results, the likelihood of ink stored in the ink chamber 111 leaking from the gap formed between the main body rib 211 and bottom wall rib 173 can be reduced.

In the ink tank 100, the fourth bottom wall 154 has the front housing section 225 and the rear housing section 226, which are formed by the portions of the bottom part 171 protruding upward. The light-emitting element 311A is positioned in the front housing space 225A defined by the front housing section 225. The light-receiving element 311B is positioned in the rear housing space 226A defined by the rear housing section 226. Hence, the light-emitting element 311A and the light-receiving element 311B are provided in the tank main body 120 by the fourth bottom wall 154 being fixed to the tank main body 120. As a result, the light-emitting element 311A and the light-receiving element 311B can be easily provided in the tank main body 120, which is molded as a single piece using a die in which a core is pulled out from a cavity in the up-down direction, and therefore opens downward.

In the ink tank 100, the rear housing space 226 and the front housing space 225 are spaced apart from each other in the front-rear direction at the bottom plate 171 of the fourth bottom wall 154. The light-emitting element 311A and the light-receiving element 311B are arranged in the front housing space 225A and the rear housing space 226A, respectively. Hence, the horizontal cross-sectional area of the ink detected by the sensor 311 is smaller than a horizontal cross-sectional area of the ink, which is detected by a sensor in a case where the light-emitting element 311A and the light-receiving element 311B are arranged outside the tank main body 120. As a result, the accuracy for detecting remaining amount of ink by the sensor 311 can be high.

In the ink tank 100, the two protruding pieces 181 are provided at the bottom of the tank tube 115. The two protruding pieces 181 extend downward from the bottom of the tank tube 115. When the ink bottle 80 is connected to the ink tank 100, even if ink stored in the ink storage chamber 147 of the ink bottle 80 flows into the ink chamber 111 through the internal space of the tank tube 115 and the ink adheres to the bottom of the tank tube 115, the adhered ink easily falls along the two protruding pieces 181. Accordingly, the formation of an ink meniscus at the opening 195 which is provided at the bottom of the tank tube 115 can be reduced. Hence, easily ensuring the flow of air between the ink chamber 111A and the ink storage chamber 147, and the flow of air between the interior and exterior of the ink chamber 111A. As a result, ink stored in the ink storage chamber 147 can be smoothly supplied from the ink storage chamber 147 to the ink chamber 111.

In the ink tank 100, each of the protruding pieces 271 is provided at the peripheral portion the corresponding one of the atmospheric communication ports 112. Each of the protruding pieces 271 extends downward. Hence, each of the protrusion pieces 271 reduces the formation of an ink meniscus at the corresponding atmospheric communication port 112. As a result, airflow into the ink chamber 111 from the outside through each of the atmospheric communication ports 112 is less likely to be obstructed.

In the ink tank 100, the tank main body 120 includes the protruding walls 230 protruding from the inner surface of the tank main body 120. The bottom wall 105 is in contact with the protruding walls 230. Since the tank main body 120 includes the protruding walls 230, the strength of the tank main body 120 can be high. Hence, the tank main body 120 is less likely to be deformed when then bottom wall 105 is fixed to the tank main body 120. Accordingly, the bottom wall 105 is fixed to the tank main body 120 by welding with high accuracy. Furthermore, the contacting area at which the bottom wall 105 and the tank main body 120 are in contact with each other is large. Hence, even if the gap between the bottom wall 105 and the main body rib 211 is large, the bottom wall 105 is less likely to be tilted when the bottom wall 105 is fixed to the tank main body 120 by welding. Additionally, since the protruding walls 230 protrude from the inner surface of the tank main body 120, an ejector pin for removing the tank main body 120 from a die is easily arranged apart from the main body rib 211. Accordingly, decrease in welding accuracy caused by the main body ribs 211 being damaged by the ejector pin is reduced. In addition, warpage that may occur during cooling of the tank main body 120 in injection molding is reduced. Furthermore, since the protrusion 267 protruding leftward from the left surface of the right outer protruding wall 235 is provided on the right outer protruding wall 235, warpage that may occur during cooling of the tank main body 120 in injection molding is easily reduced.

In the ink tank 100, the right outer protruding wall 235 and the right inner protruding wall 238 face each other the left-right direction. The rear outer protruding wall 237 and the rear inner protruding wall 241 face each other in the front-rear direction. Therefore, when the fourth bottom wall 154 is fixed to the tank main body 120 by welding, the fourth bottom wall 154 is less likely to be tilted relative to the tank main body 120.

In the multifunction peripheral 10, the shape of the inner surface of the through-hole 72 of the tank cover 110 is approximately the same as the shape of the outer circumferential surface of the protrusion 94 of the ink bottle 80, which is configured to be inserted into the through hole 72. Hence, the orientation of the ink bottle 80 can be stable in a state where the protrusion 94 is inserted into the through hole 72. The bottom wall 205 of the tank cover 110 covers a part of the bottom wall 105 of the ink tank 100. Hence, the likelihood of the outer surface of the bottom wall 105 being damaged can be reduced.

While the invention has been described in conjunction with the example structure outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

### VARIATIONS OF THE EMBODIMENT

In the ink tank 100, since the thickness of the bottom wall 105 is greater than the thickness of the film 121, the strength of the bottom wall 105 is greater than the strength of the film 121. However, the strength of the bottom wall 105 may be greater than the strength of the film 121 by the bottom wall 105 being made of resin material having a higher rigidity than the rigidity of the film 121.

In the ink tank 100, since the film 121, which is welded to the bottom wall rib 173 of the bottom wall 105, is welded to the main body rib 211 of the tank body 120, the bottom wall 105 is fixed to the tank main body 120. However, the method of fixing the bottom wall 105 to the tank main body 120 is not limited, as long as the bottom wall 105 is fixed to the tank main body 120 by welding. For example, the bottom wall 105 may be fixed to the tank main body 120 by pouring melted resin between the bottom wall rib 173 and the main body rib 211. In this case, the film 121 may also be welded to the main body rib 211 and the bottom wall rib 173. Alternatively, the film 121 need not necessarily be used. Furthermore, the bottom wall 105 may be fixed to the tank main body 120 by the main body rib 211 and the bottom wall rib 173 being melted and then being fixed to each other. In this case, the film 121 may also be welded to the main body rib 211 and the bottom wall rib 173. Alternatively, the film 121 need not necessarily be used. The method of welding is not limited, as long as the bottom wall 105 is fixed to the tank main body 120. For example, the methods of welding include: thermal welding in which external heat is applied, high-frequency welding in which high-frequency waves are used for heating, ultrasonic welding in which ultrasonic waves are used for heating, and laser welding in which laser beams are used for heating.

In the ink tank 100, the bottom wall 105 is fixed to the tank main body 120 by welding. However, the bottom wall 105 may be fixed to the tank main body 120 by methods other than welding, as long as the bottom wall 105 is fixed to the tank main body 120. For example, the bottom wall 105 may be fixed to the tank main body 120 by screws or press-fitting. In this case, the bottom wall 105 may have a sealing member, which is made of rubber and is configured to reduce ink leakage. For example, the sealing member may reduce ink leakage by closely contacting the periphery of the opening 231 and the bottom wall 105.

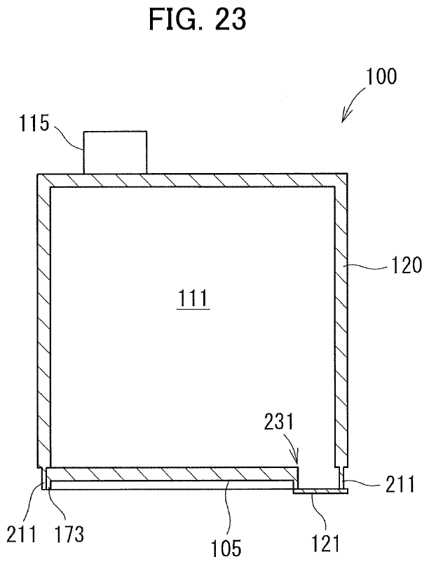

In the ink tank 100, the bottom wall 105 covers the entire opening 231. However, as shown in FIG. 23, the bottom wall 105 may cover part of the opening 231. In this case, the film 121 may cover the remaining part of the opening 231 other than the part of the opening 231 that is covered by the bottom wall 105. Since the bottom wall 105 covers part of the opening 231, the film is less likely to be damaged than a film covering the entire opening 231.

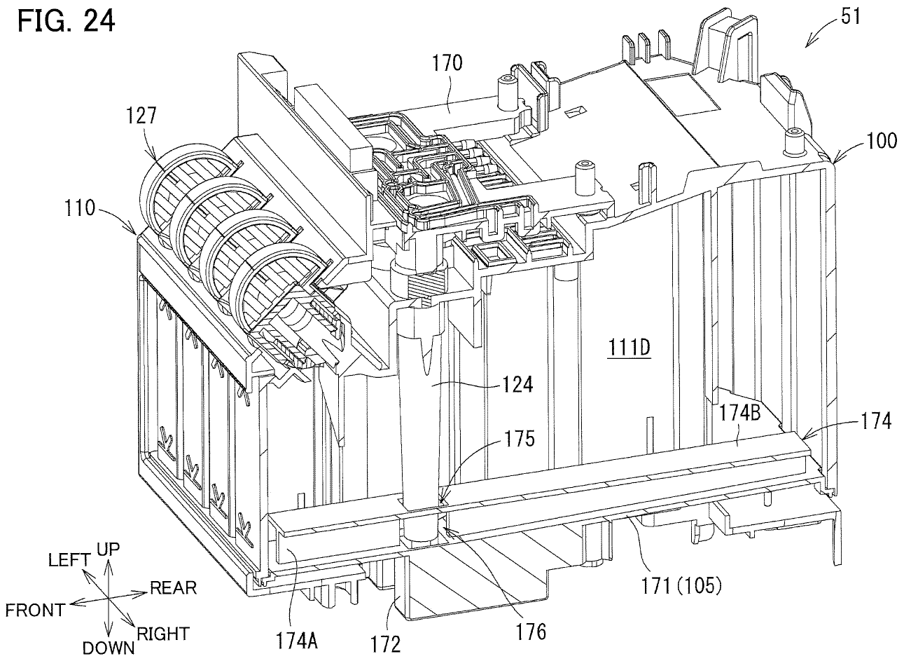

In the ink tank 100, one of the vertical plates 174A of the upper plate 174 of the bottom wall 105 extends in the left-right direction at one end in the front-rear direction of the top surface of the bottom plate 171. The other of the vertical plates 174A of the upper plate 174 of the bottom wall 105 extends in the left-right direction at the other end in the front-rear direction of the top surface of the bottom plate 171. However, as shown in FIG. 24, the vertical plate 174A may be positioned at the left-right center of the top surface of the bottom plate 171 and extend in the front-rear direction. The vertical plate 174A has a flat plate shape extending in the front-rear and up-down directions. The vertical plate 174A has a notch 176 cut out through the vertical plate 174A in the left-right direction. The notch 176 is positioned downward of the through hole 175 of the horizontal plate 174B. The notch 176 extends from the bottom of the vertical plate 174A to the top of the vertical plate 174A. The notch 176 is in communication with the through-hole 175. The outflow tube 124 extends toward the protruding space 172A through the notch 176 and the through-hole 175.

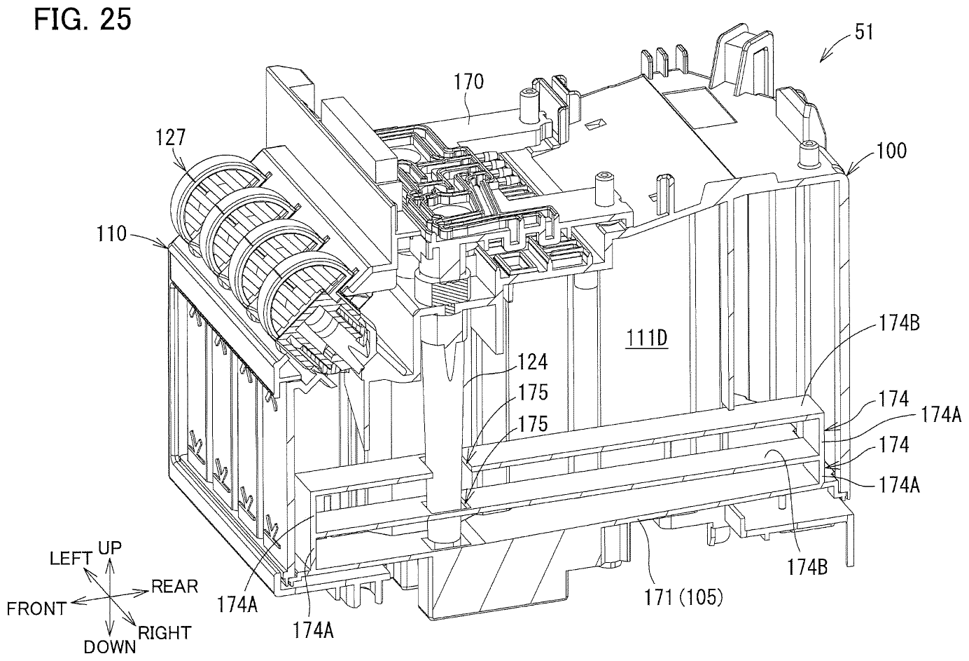

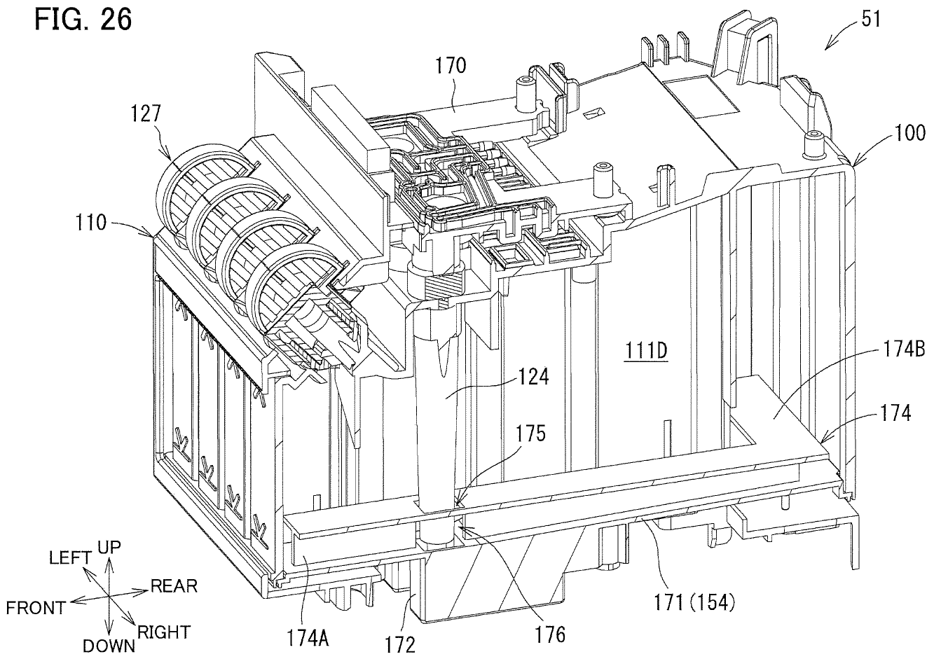

As shown in FIG. 25, the upper plate 174 of the bottom wall 105 may be two-tiered plates. In other words, an additional upper plate 174 having the same structure as the upper plate 174 is provided above that upper plate 174. Also, as shown in FIG. 26, the vertical plate 174A and horizontal plate 174B of the fourth bottom wall 154 may extend further leftward from the rear end portion of the vertical plate 174A and the rear end portion of the horizontal plate 174B, respectively.

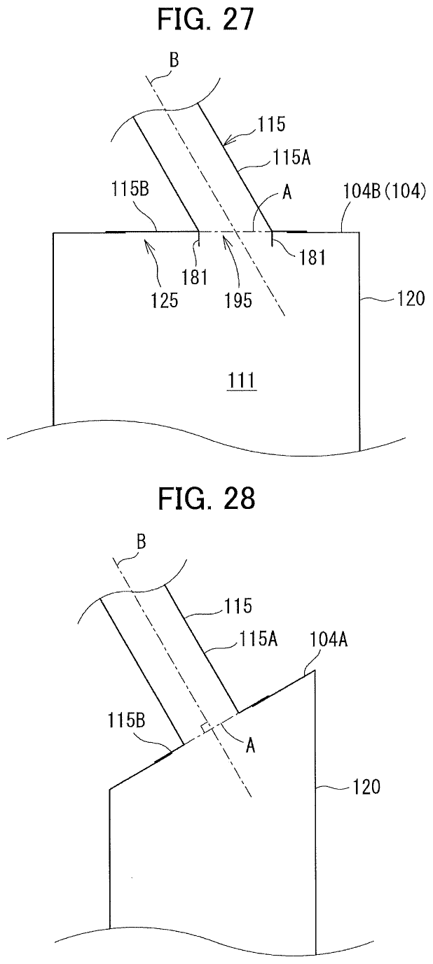

In the ink tank 100, the four tank tubes 115 and the tank main body 120 are molded as a single member through injection molding. However, the tank tubes 115 may be welded onto the injection molded tank main body 120. In this case, four openings 125 are provided at the top wall 104. The interior and exterior of each of the ink chambers 111A, 111B, 111C, and 111D are in communication with each other through the corresponding one of the four openings 125. As shown in FIG. 27, each opening 125 opens upward on the horizontal surface 104B. Each opening 125 has a circular shape. The openings 125 are each an example of the second opening.

Each tank tube 115 has a tube body 115A and a base 115B. The tube body 115A is a circular tube that extends in the extension direction. The top of the tube body 115A opens upward. The bottom of the tube body 115A opens downward. The outer diameter of each of the tube bodies 115A is smaller than the inner diameter of the corresponding one of the openings 125. Each tube body 115A covers a part of the corresponding one of the openings 125.

The base 115B is positioned at the bottom of the outer surface of the tube body 115A. The base 115B annularly protrudes from the outer surface of the tube body 115A. Each base 115B covers part of the corresponding one of the openings 125. A virtual plane A having the bottom surface of the base 115B and a virtual line B passing through the circular center of the tube body 115A cross each other at an acute angle. Since the bottom surface of the base 115B is heated by ultrasonic waves, the bottom surface of the base 115B is welded to the periphery of the opening 125. Incidentally, the method of welding the base 115B is not limited to the welding using ultrasonic waves. As a result, each of the tank tubes 115 is fixed to the horizontal surface 104B of the top wall 104. The interior and exterior of each of the ink chambers 111A, 111B, 111C, and 111D are in communication with each other through the internal space of the corresponding one of the tank tubes 115 and the corresponding one of the openings 125. The base 115B is an example of the base portion.

In the variation shown in FIG. 27, the base 115B of the tank tube 115 is fixed to the horizontal surface 104B of the top wall 104 by welding. Hence, the structure of a die used for forming the tank body 120 is simpler than a die used for forming the tank tube 115 and the tank main body 120 as a single member. In other words, even if the tank main body 120 may have an undercut shape due to the tube body 115A of the tank tube 115 extending diagonally upward and forward from the base 115B, the tank main body 120 can be easily formed.

In the variation shown in FIG. 27, since the base 115B of the tank tube 115 is welded to the horizontal surface 104B, the base 115B is fixed to the horizontal surface 104B in the vertical direction. As a result, even if the tank tube 115 extends diagonally upward and forward from the base 115B, the tank tube 115 is easily fixed to the tank main body 120.

In the ink tank 100, the tube body 115A of each tank tube 115 covers part of the corresponding opening 125. However, the tube body 115A may cover the entire opening 125. In this case, the outer diameter of the tube body 115A is larger than the inner diameter of the opening 125. In this case, the protruding pieces 181 may extend downward from the peripheral portion of the opening 125.

In the variation shown in FIG. 27, the base 115B of the tank tube 115 is welded to the horizontal surface 104B, which has the opening 125 opening upward. However, as shown in FIG. 28, the base 115B may be welded to the sloped surface 104A. In this case, the virtual plane A having the bottom surface of the base 115B and the virtual line B passing through the circular center of the tube body 115A orthogonally intersect.

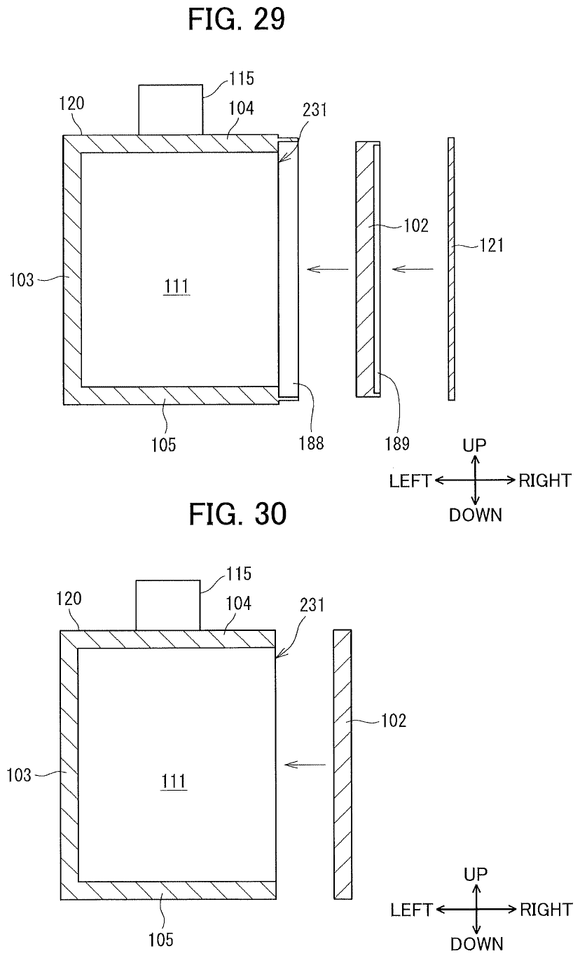

In the ink tank 100, since the tank main body 120 is molded as a single piece using a die in which a core is pulled out from a cavity in the up-down direction, the tank main body 120 opens downward. However, the tank main body 120 may open horizontally by the tank main body 120 being molded as a single piece using a die in which a core is pulled out from a cavity in the horizontal direction. As shown in FIG. 29, the tank main body 120 opens rightward in the left-right direction. Incidentally, the tank main body 120 may open leftward or rearward, as long as the tank main body 120 opens horizontally. Also, note that a single ink chamber 111 is provided in FIG. 29.

In this case, the tank main body 120 includes a main body rib 188 at the right end portion of the tank main body 120. The main body rib 188 protrudes slightly rightward from the right edges of the front wall 101, top wall 104, bottom wall 105, and the rear wall 106. The main body rib 188 has a continuous annular shape along the right edges of the front wall 101, top wall 104, bottom wall 105, and rear wall 106. The main body rib 188 defines the opening 231 through which the interior and exterior of the ink chamber 111 are in communication with each other.

The entire right wall 102 is in contact with the entire right edges of the front wall 101, top wall 104, bottom wall 105, and rear wall 106. In other words, the right wall 102 is in contact with the entire periphery of the opening 231. As a result, the right wall 102 covers the entire opening 231, through which the interior and exterior of the ink chamber 111 are in communication with each other.

The right wall 102 includes a right wall rib 189. The right wall rib 189 is positioned at the outer edge of the right surface of the right wall 102. The right wall rib 189 protrudes slightly rightward from the right surface of the right wall 102. The right wall rib 189 is continuously formed along the outer edge of the right surface of the right wall 102. The right wall rib 189 has an annular shape. The entire right wall rib 189 faces the entire main body rib 188. The right wall rib 189 is spaced apart from the main body rib 188 with a slight interval.

The film 121 covers the entire right surface of the right wall 102. The right wall 102 is fixed to the tank main body 120 by the film 121 being welded to both the right wall rib 189 and the main body rib 188. The right wall 102 is an example of the cover. Incidentally, the right wall rib 189 and the main body rib 188 may be omitted.

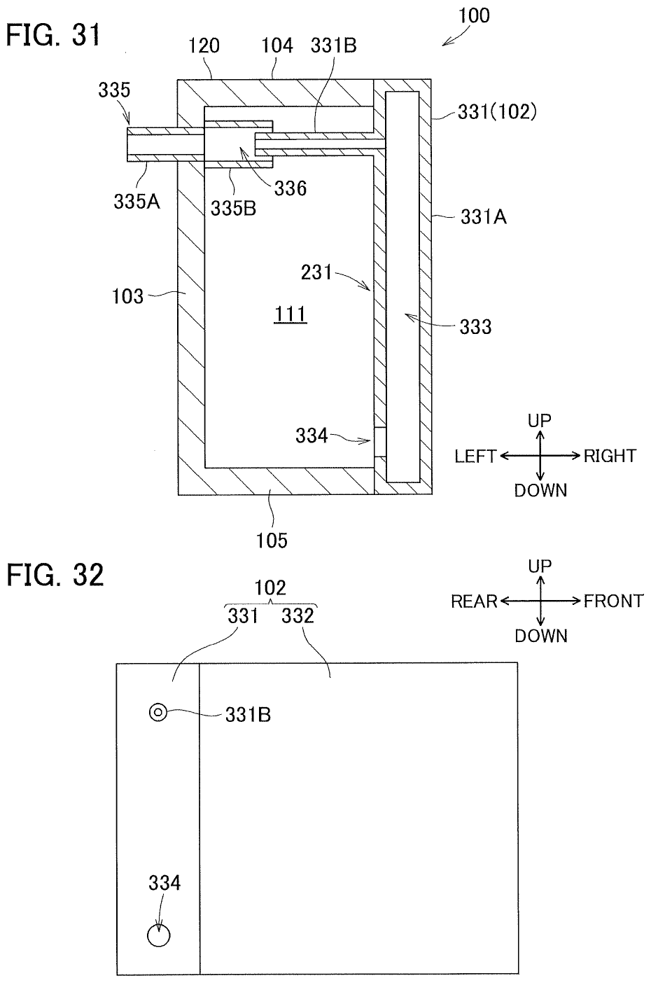

As shown in FIG. 31, in a case where the right wall 102 is fixed to the tank main body 120, part of the opening 231 of the tank main body 120 may be covered by an outflow tube 331. In this case, the outflow tube 124 described in the above embodiment is omitted. Note that, although the main body rib 188 and the right wall rib 189 are omitted from FIG. 31, the main body rib 188 and the right wall rib 189 may be provided.

Specifically, as shown in FIG. 32, the right wall 102 includes a right plate 332 and the outflow tube 331. The right plate 332 has a flat plate shape extending in the front-rear and up-down directions. The outflow tube 331 is fixed to the rear end of the right plate 332. The outflow tube 331 defines an ink channel 333 through which ink stored in the ink chamber 111 flows toward the outside. The ink channel 333 is an example of the liquid channel. The outflow tube 331 includes a tube main body 331A and a connector tube 331B. The tube main body 331A extends upward from the bottom edge of the right wall 102 to the top of the right wall 102 at the rear end of the right wall 102. An inlet 334 is provided on the left surface of the tube main body 331A. The inlet 334 opens leftward. The inlet 334 is positioned at the lower end portion of the tube main body 331A. The connector tube 331B extends leftward from the left surface of the tube main body 331A. The connector tube 331B is positioned at the upper end portion of the tube main body 331A.

The tank main body 120 includes a connecting portion 335 to which the ink tube 32 and the outflow tube 331 are connected. The connecting portion 335 is positioned at the rear end portion of the upper end portion of the left wall 103. The connecting portion 335 defines a connecting channel 336 connecting the ink chamber 111 and the ink tube 32. The connecting portion 335 has a tube connecting port 335A and a tube connecting port 335B. The tube connecting port 335A protrudes further leftward than the left surface of the left wall 103. The tube connecting port 335A is connected to the ink tube 32. The tube connecting port 335B is positioned on the right end of the tube connecting port 335A. The tube connecting port 335B is positioned in the ink chamber 111. The tube connecting port 335B opens rightward.

In the variation shown in FIGS. 31 and 32, when the right wall 102 is fixed to the tank main body 120, the connector tube 331B is inserted into the tube connecting port 335B. Accordingly, the outer circumference of the connector tube 331B closely contacts the sealing member (not shown) provided at the tube connecting port 335B. As a result, ink stored in the ink chamber 111 can be supplied to the recording head 39 through the outflow tube 331, the connecting portion 335, and the ink tube 32. In this state, the right plate 332 of the right wall 102 and the outflow tube 331 covers the entire opening 231 of the tank main body 120.

In the variation shown in FIGS. 31 and 32, since the right wall 102 is fixed to the tank main body 120, the outflow tube 331 is provided in the ink chamber 111. Accordingly, the outflow tube 331 can be easily provided at the tank main body 120, which is molded as a single piece using a die in which a core is pulled out from a cavity in the horizontal direction, and therefore opens downward. Furthermore, since the outflow tube 331 covers part of the opening 231 of the tank main body 120, the ink channel 333 can be formed by simply fixing the right wall 102 to the tank main body 120, without providing extra space for the outflow pipe 331.

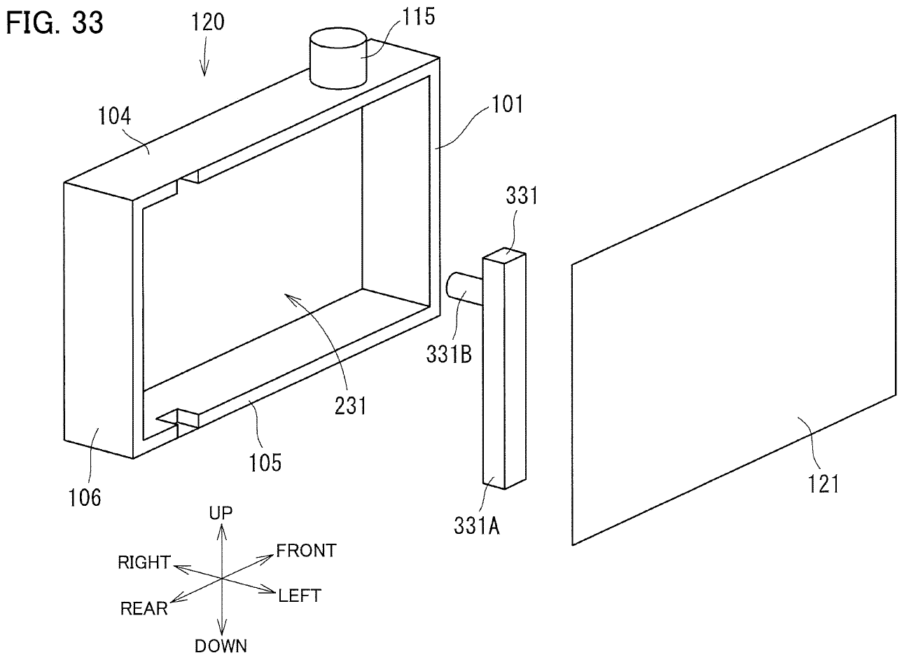

In the variation shown in FIGS. 31 and 32, the right plate 332 and the outflow tube 331 covers the entire opening 231 of the tank main body 120. However, as shown in FIG. 33, the outflow tube 331 and the film 121 may cover the entire opening 231 of the tank main body 120. In the variation shown in FIG. 33, the film 121 is welded to the left edge of the tank main body 120 and the left surface of the outflow tube 33 in a state where the outflow tube 331 is fitted into the left edge of the tank main body 120 through the opening 231, which opens leftward. The strength of the outflow tube 331 is greater than the strength of the film 121, due to the outflow tube 331 having a thickness greater than the thickness of the film 121, for example. The outflow tube 331 is an example of the cover. Incidentally, the left surface of the outflow tube 331 may have an opening, which opens leftward. In this case, the film 121 may be welded to the left surface of the outflow tube 331 such that the film 121 seals the opening of the outflow tube 331. Also, in this case, the space defined by the outflow tube 331 and the film 121 is an example of the liquid channel.

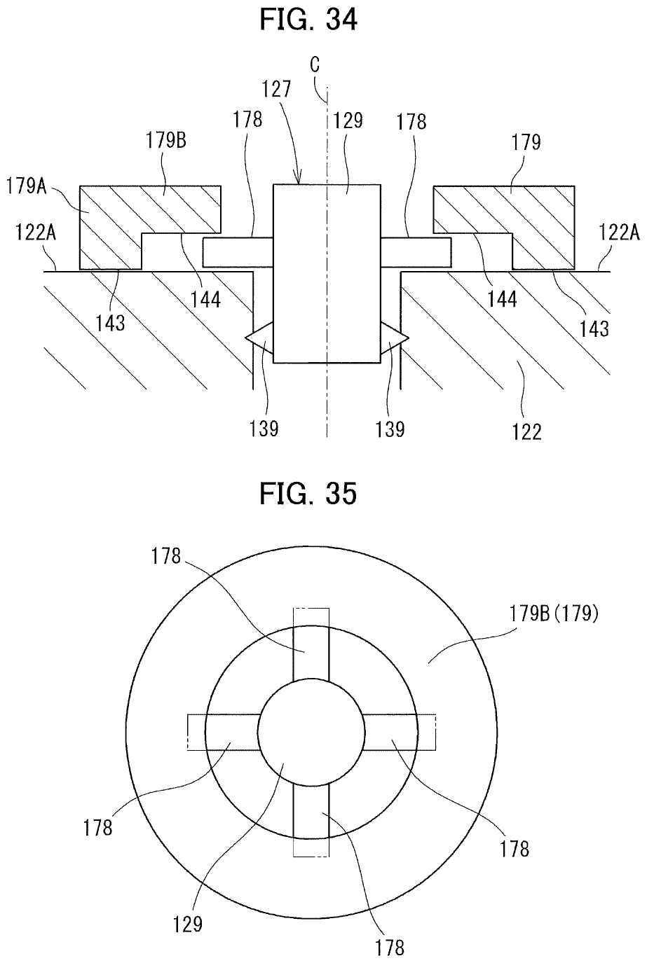

In the ink tank set 51, the rubber portion 129 of each tank cap 127 has the protruding portion 139. In a state where the rubber portion 129 of each tank cap 127 is inserted in the internal space of the corresponding annular wall 122, the protruding portion 139 is in liquid-tight contact with the inner circumferential surface 123 of the corresponding annular walls 122. However, as shown in FIGS. 34 and 35, each tank cap 127 may further include protrusions 178 at a position further upward than the protruding portions 139 on the outer surface of the rubber 129 for restricting the tank cap 127 from being removed from the corresponding annular wall 122. In this case, a stopper part 179 is provided on the corresponding annular wall 122.

The stopper part 179 of each annular wall 122 has a base part 179A and a contact part 179B. The base part 179A is positioned on a top surface 122A of the annular wall 122. The base part 179A has a circular annular shape having an inner diameter greater than the inner diameter of the annular wall 122. The circular center of the base part 179A overlaps a center axis C passing through the circular center of the annular wall 122. The base part 179A has a bottom surface 143 which is welded to the top surface 122A of the annular wall 122. The contact part 179B extends from the upper portion of the inner surface of the base part 179A inward in a radial direction of the base part 179A. The contact part 179B has a circular annular shape. The inner diameter of the contact part 179B is greater than the inner diameter of the annular wall 122. The circular center of the contact part 179B overlaps the center axis C passing through the circular center of the annular wall 122. The bottom surface of 144 of the contact part 179B is positioned further upward than the top surface 122A of the annular wall 122.

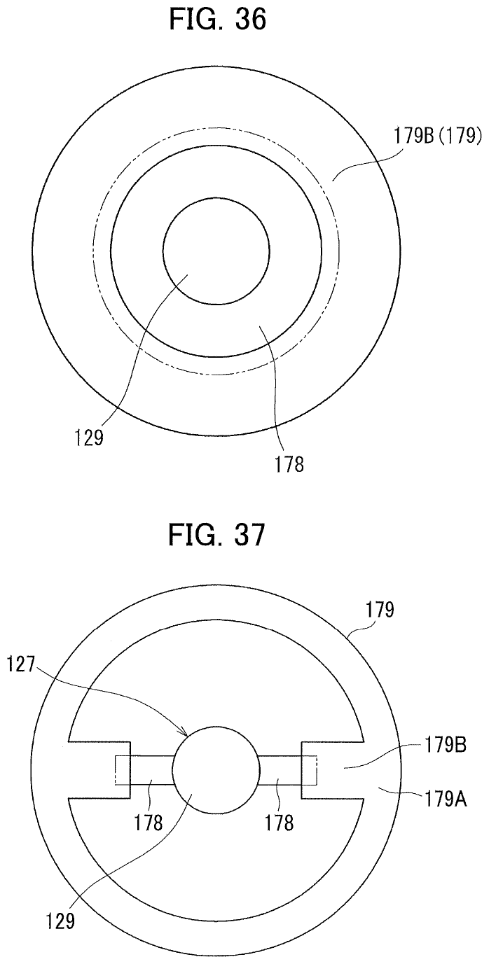

The protrusions 178 extend outward from the outer circumferential surface of the rubber portion 129. As shown in FIG. 35, the four protrusions 178 are arranged at 90-degree angular intervals with respect to the circular center of the rubber portion 129. Incidentally, as shown in FIG. 36, the protrusion 178 may protrude outward from the outer surface of the rubber portion 129 such that the protrusion 178 has a circular annular shape. The outer edge of each protrusion 178 is positioned further outward than the inner surface of the contact part 179B in the radial direction. The outer edge of each protrusion 178 is positioned between the bottom surface of the contact part 179B and the top surface of the annular wall 122. The length of the protrusion 178 in the up-down direction is slightly smaller than the length between the bottom surface 144 of the contact part 179B and the top surface 122A of the annular wall 122 in the up-down direction.

In the variation shown in FIGS. 34 and 35, the four protrusions 178 are positioned between the bottom surface 144 of the contact part 179B and the top surface 122A of the annular wall 122. Since the four protrusions 178 contact the bottom surface 144 of the contact part 179B, the likelihood of the tank cap 127 being removed from the annular wall 122 can be reduced. The stopper part 179 is fixed to the tank main body 120 by the bottom surface 143 of the base 179A being welded to the top surface 122A of the annular wall 122. Therefore, even if the tank main body 120 may have an undercut shape due to the stopper part 179 being provided on the tank main body 120, the tank main body 120 can be easily molded.

In the variation shown in FIG. 35, the contact part 179B of the stopper part 179 has a circular annular shape. However, as shown in FIG. 37, the contact part 179B may have a protruding shape, which protrudes further inward than the inner surface of the base part 179A in the radial direction. As shown in FIG. 37, the two contact parts 179B are provided on the inner surface of the base part 179A at 180-degree intervals relative to the circular center of the base part 179A. Two protrusions 178 are provided on the outer circumferential surface of the rubber portion 129 at 180-degree intervals relative to the circular center of the rubber portion 129. Each protrusion 178 is positioned between the bottom surface 144 of the contact part 179B and the top surface 122A of the annular wall 122.

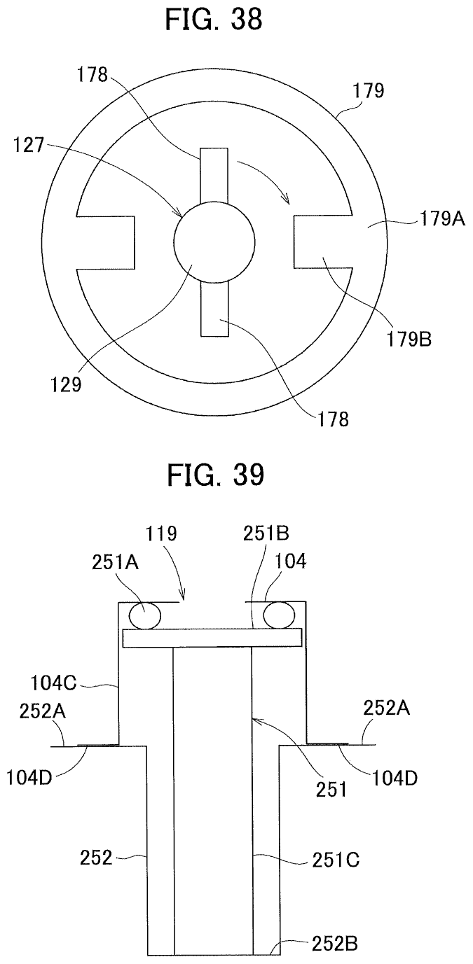

In the variation shown in FIG. 38, a user inserts the rubber portion 129 into the internal space of the annular wall 122 such that the protrusions 178 of the rubber portion 129 does not overlap the contact part 179B of the stopper part 179 in the up-down direction. Thereafter, as shown in FIG. 37, the user positions each protrusion 178 between the bottom surface 144 of the contact part 179B and the top surface 122A of the annular wall 122 by rotating the rubber portion 129. As a result, the tank cap 127 is restricted from being removed from the annular wall 122. In the variation shown in FIG. 37, the tank cap 127 can be easily inserted into the internal space of the annular wall 122. Also, the tank cap 127 is restricted from being removed from the annular wall 122. Note that the annular wall 122 has been omitted from FIGS. 37 and 38 for simplicity.

As shown in FIG. 39, the ink tank 100 may also have a valve 251 and a base 252. The valve 251 is configured to open and close the communication port 119. The base 252 supports the valve 251. The communication port 119 is an example of the third opening. Note that the tank tube 115 has been omitted from FIG. 39 for simplicity. Furthermore, in FIG. 39, the top wall 104 has a tubular portion 104C in which the communication port 119 is positioned. The tubular portion 104C extends upward.

The base 252 is positioned further downward than the tubular portion 104C. A top portion 252A of the base 252 expands along a virtual plane perpendicular to a direction in which a valve body 251B (described later) is movable. Part of the top portion 252A is recessed downward. Accordingly, a vertical cross section of the base 252, which is taken in a plane passing through the part of the top portion 252A and is parallel to the direction in which the valve body 251B is movable, has a general U-shape. The base 252 has the top portion 252A and a bottom surface 252B. The bottom surface 252B of the base 252 faces the communication port 119 in the up-down direction. The top wall 104 has the inner surface 104D. The top portion 252A of the base 252 is welded to the inner surface 104D of the top wall 104.

The valve 251 includes a sealing member 251A, the valve body 251B, and an urging member 251C. The sealing member 251A is fixed to the inner surface of the top of the tubular portion 104C. The sealing member 251A has an annular shape surrounding the communication port 119. The sealing member 251A is made of rubber.

The valve body 251B is positioned between the base 252 and the top wall 104. The valve body 251B has a flat plate shape extending along a virtual plane perpendicular to the direction in which the valve body 251B moves. The shape of the outer peripheral surface of the valve body 251B is approximately equivalent to the shape of the inner circumferential surface of the tubular portion 104C. The valve body 251B is movable in an axial direction of the tubular portion 104C within the tubular portion 104C. The valve body 251B is movable between a closed position and an open position. At the closed position, the valve body 251B contacts the sealing member 251A to close the communication port 119. At the open position, the valve body 251B is apart from the sealing member 251A to open the communication port 119. The communication port 119 is an example of the third opening.

The urging member 251C is a coil spring, which is configured to expand and contract in the direction in which the valve body 251B moves. One end of the urging member 251C in the expansion and contraction direction is supported by the bottom surface 252B of the base 252. The other end of the urging member 251C in the expansion and contraction direction is in contact with the valve body 251B. The urging member 251C urges the valve body 251B toward the closed position. Accordingly, the valve 251 is disposed between the tubular portion 104C and the base 252 such that the valve 251 can open and close the communication port 119. The valve 251 is an example of the valve.

In the variation shown in FIG. 39, when the ink bottle 80 is connected to the ink tank 100, the valve body 251B moves from the closed position to the open position against the urging force of the urging member 251C due to the valve body 251B being pressed by the bottle tube 96 of the ink bottle 80 configured to be inserted into the connecting port 119. As a result, the ink storage chamber 147 of the ink bottle 80 communicates with the interior of the ink chamber 111 through the internal space of the bottle tube 96.

In the variation shown in FIG. 39, the valve 251 can be disposed in space between the top wall 104 and the base 252. Accordingly, the valve 251 can be easily arranged in the tank main body 120, which opens downward due to being formed as a single piece using a die in which a core is pulled out from a cavity in the up-down direction.

In the ink tank 100, the tank tube 115 and the communication port 119 are arranged at the front end portion of the top wall 104, but may be arranged at the horizontal surface 104B of the top wall 104 instead. Furthermore, either of the tank tube 115 and the communication port 119 may be omitted. In a case where the tank tube 115 is omitted, the opening 95 of the ink bottle 80, through which the tank tube 115 is inserted, is omitted. In this case, the valve 161 of the ink bottle 80 may also be omitted. In this case, the bottle tube 96 of the ink bottle 80 may have two passages. One of the two passages is a passage through which ink flows. The other of the two passages is a passage through which air flows. On the other hand, in a case where the communication port 119 is omitted, the bottle tube 96 of the ink bottle 80 is omitted. In this case, the tank tube 115 may have two passages. One of the two passages is a passage through which ink flows. The other of the two passages is a passage through which air flows.

What is claimed is:

1. A tank comprising:
a frame defining:
a storage chamber for storing liquid; and
a first opening that faces in a downward direction or in a horizontal direction in a state where the tank is attached to a liquid ejection device; and
a cover fixed to the frame, the cover covering at least part of the first opening,
wherein a strength of the cover is greater than a strength of a film.

2. The tank according to claim 1,
wherein the cover is fixed to the frame by welding.

3. The tank according to claim 1,
wherein the cover has a protruding part protruding outward.

4. The tank according to claim 2,
wherein the tank further comprises:
the film covering a remaining part of the first opening other than the part of the first opening covered by the cover.

5. The tank according to claim 3, further comprising:
an outflow port allowing liquid stored in the storage chamber to flow to an outside of the storage chamber through the outflow port,
wherein the first opening faces in the downward direction,
wherein the frame and the cover define the storage chamber by the cover covering the at least part of the first opening,
wherein the protruding part protrudes in the downward direction, the protruding part having an internal space in communication with the storage chamber, and
wherein the outflow port is positioned in the internal space.

6. The tank according to claim 1, further comprising:
an outflow port allowing liquid stored in the storage chamber to flow to an outside of the storage chamber through the outflow port,
wherein the first opening faces in the downward direction, and
wherein the cover has:
a bottom plate part, the frame and the bottom plate part defining the storage chamber by the bottom plate part covering the at least part of the first opening; and
a flat plate part extending in the horizontal direction, the flat plate part being positioned further upward than both the outflow port and the bottom plate part.

7. The tank according to claim 1,
wherein the cover covers an entirety of the first opening.

8. The tank according to claim 2,
wherein the tank further comprises the film, and
wherein the cover is fixed to the frame by the film being welded to both the frame and the cover.

9. The tank according to claim 1, further comprising:
a liquid detector configured to detect liquid stored in the storage chamber,
wherein the cover includes at least part of the liquid detector.

10. The tank according to claim 9,
wherein the first opening faces in the downward direction,
wherein the cover has a bottom plate part covering the at least part of the first opening, and
wherein the liquid detector has:
a first accommodation portion protruding upward from the bottom plate part and defining a first accommodation space;
a second accommodation portion protruding upward from the bottom plate part and defining a second accommodation space, the second accommodation portion being spaced apart from the first accommodation portion; and
a sensor having:
a light emitting element disposed in the first accommodation space; and
a light receiving element disposed in the second accommodation space.

11. The tank according to claim 1,
wherein the cover has a liquid passage allowing liquid to flow from the storage chamber to an outside of the storage chamber through the liquid passage,
wherein the first opening faces in the horizontal direction, and
wherein the liquid passage covers the at least part of the first opening.

12. The tank according to claim 1, further comprising:
a base portion; and
a tube body extending from the base portion, the tube body providing a communication between the storage chamber and an outside of the tank,
wherein the frame further defines a second opening,
wherein the tube body covers at least part of the second opening,
wherein the base portion is fixed to the frame, and
wherein the tube body extends diagonally upward in a state where the tank is attached to the liquid ejection device.

13. The tank according to claim 12,
wherein the second opening faces in an upward direction, and
wherein the base portion covers at least part of the second opening.

14. The tank according to claim 1, further comprising:
a tube body providing a communication between the storage chamber and an outside of the tank, the tube body having an opening in communication with the storage chamber,
wherein the frame includes a protruding piece positioned inside the storage chamber, the protruding piece extending from a peripheral portion of the opening of the tube body.

15. The tank according to claim 1,
wherein the frame includes:
an atmospheric communication port providing a communication between the storage chamber and an outside of the tank; and
a protruding piece positioned inside the storage chamber, the protruding piece extending from a peripheral portion of the atmospheric communication port.

16. The tank according to claim 1,
wherein the frame further defines a third opening,
the tank further comprising:
a base portion fixed to the frame, the base portion facing the third opening; and
a valve disposed between the frame and the base portion, the valve being configured to open and close the third opening.

17. The tank according to claim 2,
wherein the frame includes a first protruding wall protruding from an inner surface of the frame, and
wherein the cover is in contact with the first protruding wall.

18. The tank according to claim 17,
wherein the frame includes a second protruding wall protruding from the inner surface of the frame, the second protruding wall facing the first protruding wall, and
wherein the cover is in contact with the second protruding wall.

19. The tank according to claim 1,
wherein the tank further comprises the film.

20. A liquid ejection device comprising:
the tank according to claim 1;
a head configured to eject liquid stored in the tank; and
a tank cover covering the tank,
wherein the tank cover includes:
a fixing portion for positioning a bottle relative to the tank in a state where the bottle is connected to the tank; and
a cover portion covering at least part of the cover of the tank.
